(19) United States
(12) Patent Application Publication
(10) Pub. No.: US 2025/0164011 A1
(43) Pub. Date: May 22, 2025

(54) REGENERATIVE THERMAL OXIDIZER GAS FLOW CONTROL SYSTEM AND RELATED METHODS

(71) Applicant: Nestec, Inc., Pen Argyl, PA (US)

(72) Inventor: James T. CASH, Hackettstown, NJ (US)

(73) Assignee: Nestec, Inc., Pen Argyl, PA (US)

(21) Appl. No.: 18/950,471

(22) Filed: Nov. 18, 2024

Related U.S. Application Data
(60) Provisional application No. 63/599,783, filed on Nov. 16, 2023.

(51) Int. Cl. F16K 1/16

(52) U.S. Cl. CPC F16K 1/165

(57) ABSTRACT

A gas flow control valve with pivotable damper blade usable in a regenerative thermal oxidizer (RTO) unit or other gas flow control application. The valve in one embodiment is a four-way valve with dual operating positions to control gas flow through four ducts coupled to the valve. To enhance positively sealing the blade to the valve housing in each position the seal, selectively actuatable electromagnetic clamps are provided which magnetically draw the blade toward the active blade end seat acted upon by gas pressure in a direction which tends to force the blade away from its seat. The blade is actuated directly by an actuator system via an operating rod to change position of the valve. A seal air system supplies pressurized air to the valve seats. A programmable controller automatically controls actuation of the electromagnets, seal air, and blade positional changes.

### CROSS-REFERENCE TO RELATED APPLICATIONS

The present application claims the benefit of priority to U.S. Provisional Application No. 63/599,783 filed Nov. 16, 2023, which is incorporated herein by reference in its entirety.

### BACKGROUND

The present invention relates generally to Regenerative Thermal Oxidizer (RTO) systems used for reducing volatile organic compound (VOC) concentrations in process gas emission streams, and more particularly to gas flow control systems usable for RTO systems.

Regenerative Thermal Oxidizers (RTOs) are energy efficient air pollution control devices which have been used for decades to convert volatile organic compounds (VOC's) in a process gas emission stream emitted by industrial processes into harmless compounds of H20 and CO2 through the use of heat before exhausting the stream to atmosphere. It is recognized that such gas streams include air which is a gas. RTOs operate by heating the gas stream to elevated temperatures such as for example about 1500 degrees F. (Fahrenheit) to achieve the VOC conversion. To reduce supplemental heat from combusting fossil fuels in the RTO as the heat source, regenerative systems can recover over 95% of the heat energy used to oxidizer by repeatedly absorbing and desorbing the hot gas in ceramic heat exchange media beds. This in turn requires an interruption and reversal every few minutes of the gas flow as it passes through a preheated and post heat ceramic media beds. This function has been done by a variety of valve styles, the most common being butterfly, poppet and rotary valves. Each valve type has advantages and disadvantages. These valves are subject to 300,000 cycles a year, varying gas compositions, particulate, moisture and temperatures providing a challenge design in both low maintenance and tight performance without excessive cost and complicated manufacturing.

Butterfly valves having dampers installed in gas ducts have the advantage of balanced forces on the damper blade so that the force to move the valve does not vary significantly based on air pressures and speeds. The main disadvantage and challenge in an RTO application that allow use of butterfly valves for gas flow control however has been to maintain adequate pressure between the blade and the valve seats to eliminate bowing/deflection of some parts of the blade away from the seat caused by differential gas pressure acting counter to the force required to maintain a seal, thereby resulting in leakage through the affected seats.

Improvements in gas sealing are desired which would allow use of butterfly type valves for gas flow control under the extreme cyclical service conditions of an RTO system.

### BRIEF SUMMARY

An improved gas flow control valve usable in one embodiment for a Regenerative Thermal Oxidizer (RTO) is disclosed herein having features which reduces and/or eliminates the most common issues experienced with sealing a high cycling valve. Specifically, the flow control valve provides a butterfly type damper valve with improved valve actuation and gas seals at the valve seats that overcome the problems noted above. The valve in one embodiment is configured for physical and fluid coupling to gas ducts having a rectilinear cross-sectional shape.

A single damper blade, four-way bi-directional valve as disclosed herein with improved gas seals advantageously replaces the need for two or four valves of the butterfly or poppet style of past RTO units. The single valve is operable to direct gas flow in reverse directions through two heat recovery ceramic beds of the RTO unit thus reducing the number of valves and actuation systems required. A single controller 300 may be used to pivotably alter the valve damper blade in a simple two-position blade control scheme comprising (1) a normal operating position to direct a untreated process gas emission stream through the ceramic bed material of the RTO unit in a first direction for reduction in VOC concentrations and subsequent discharge from the unit to atmosphere, and (2) a regenerative operating position in which the flow direction through to beds is reversed in an opposite direction to reheat the ceramic bed material. The single bi-directional valve is more compact and mechanically simpler than using multiple individual valves of prior poppet or butterfly designs to achieve the same gas flow control. This reduces complexity of the gas flow control system thereby enhancing reliability and reducing maintenance.

The proposed gas flow control valve arrangement and drive system improves the valve sealing in simple on-off butterfly type damper valve operation utilizing a single damper blade in one aspect via provision of an electromagnetic clamp provided by an electromagnet which forms part of the blade seating system associated with the blade end sealing points which are problematic for forming a good gas seal. A pair of electromagnets are provided to form a fluid seal between the damper blade and housing when the blade is in both operation positions. Specifically, the electromagnetic clamp minimizes or eliminates flow leakage past and through the gas seal on the half of the blade which is acted upon by the gas pressure in a direction opposed and counter to the force required to maintain contact between the mating sealing surfaces of the blade and valve seat plate at the blade ends. Gas pressure can cause the blade to bow and deflect away from the valve seat on this half of the damper blade tending to force the blade off the seat plate resulting in flow leakage past the seal.

According to another aspect, an improved damper blade actuation design is provided. The damper blade is actuated and moved between its two positions by an operating rod of an actuator coupled to the blade. This contrasts with the usual butterfly valve in which the blade position is changed by rotating the blade shaft via applying torque thereto generated by an electric motor. The equipment and operational benefits of direct blade actuation made possible via use of the electromagnetic clamps are described further herein.

According to another aspect, a pressurized air seal system is provided which supplies sealing air to both the end/diagonal and lateral valve seat plates to further eliminate or reduce gas leakage past the seal. The seal air is delivered preferably at a greater pressure than the gas pressure flowing through the gas flow control valve.

The gas flow control valve and associated features disclosed herein may also be used with equal benefit in a Regenerative Catalytic Oxidizer (RCO) in which VOCs are eliminated from the gas emission stream through use of a catalyst at lower operating temperatures rather than the higher temperatures used to destroy VOCs in RTO units. In addition, the valve may also be used in applications not associated with VOC control altogether wherever a multi-directional gas control is needed in any commercial or industrial process. Accordingly, the gas flow control valve is not limited in its applications to VOC control alone.

Although the gas flow control valve disclosed herein is described for use in a 4-way control valve to alternate flow between 4 ducts such as in an RTO/RCO application, the valve may be used in other applications as a 3-way control valve to alternate flow between 3 ducts, or in yet other applications as a 2-way valve for simple flow on/off control. The benefits provided by the electromagnetic clamps, seal air system, and directly damper blade actuation described herein can be realized for numerous gas flow control applications depending on the particular needs of each.

### BRIEF DESCRIPTION OF THE DRAWINGS

The present invention will become more fully understood from the detailed description and the accompanying drawings, wherein like elements are labeled similarly and in which:

FIG. 1 is a perspective view of a representative RTO (regenerative thermal oxidizer) unit incorporating a gas flow control valve according to the present disclosure;

FIG. 2 is a second perspective view thereof;

FIG. 3 is a partial perspective view thereof with fan assembly removed to reveal the internals and gas flow paths of the flow control valve;

FIG. 4 is an enlarged detail perspective view of the gas flow control valve taken from FIG. 3;

FIG. 5 is a side cross sectional perspective view of the gas flow control valve showing electromagnetic clamps inside the valve which work with the damper blade end seals to improve gas sealing performance;

FIG. 6 is a side cross-sectional of the gas flow control valve

FIG. 7 is a an exploded perspective view of the valve housing;

FIG. 8 is a side cross-sectional view of the valve housing showing valve seat of the damper blade formed by a plurality of lateral seat plates and end seat plates;

FIG. 9 is an assembled perspective view of the valve housing;

FIG. 10 is a cross-sectional perspective view of the gas flow control valve with damper blade showing the valve coupled to the RTO unit gas inlet duct and a valve actuator mounted to a portion of the gas inlet duct;

FIG. 11 is a side view of the gas flow control valve and inlet duct;

FIG. 12 is a full outer perspective view thereof;

FIG. 13 is a first partial detailed side view of one of the damper blade end seat seals showing a electromagnetic clamp assembly engageable with the damper blade according to the present disclosure;

FIG. 14 is a second partial side detailed view thereof showing double engaged with the electromagnetic clamp assembly;

FIG. 15 is a rear perspective view of the damper blade of the gas flow control valve showing details of construction;

FIG. 16 is an internal side view of the gas flow control valve with the valve damper blade in a regeneration gas flow position forming a regeneration gas flow path through the ceramic media beds of RTO unit;

FIG. 17 is an internal side view thereof with the valve damper blade in an actuated half-way position;

FIG. 18 is an internal side view thereof with the valve damper blade in a normal gas flow position forming a normal gas flow path through the ceramic media beds RTO unit;

FIG. 19 is an enlarged view showing an electromagnet target plate on the rear of the damper blade engageable with the electromagnet of one of the electromagnetic clamps of the valve;

FIG. 20 is a perspective view of the gas flow control valve showing a pressurized seal air system for the valve seat seals;

FIG. 21 is an enlarged view of a portion of one of plurality of lateral seats showing details of the seal air channel and directional seal air flow arrows showing the seal air discharge path form the lateral seat;

FIG. 22 is a perspective view of the gas flow control valve showing an alternative vacuum or negative pressure seal system for the valve seat seals;

FIG. 23 is a side view of the gas flow control valve showing an external damper blade electromagnetic clamp arrangement; and

FIG. 24 is a cross-sectional perspective view of the RTO unit showing the internals thereof including the ceramic media beds and the gas flow control valve fluidly coupled to the interior space of the RTO unit.

All drawings are schematic and not necessarily to scale. Features shown numbered in certain figures which may appear un-numbered in other figures are the same features unless noted otherwise herein.

### DETAILED DESCRIPTION

The features and benefits of the invention are illustrated and described herein by reference to non-limiting exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, any references cited herein are hereby incorporated by reference in their entireties. In the event of a conflict in a definition in the present disclosure and that of a cited reference, the present disclosure controls.

As may be used herein, the terms “hermetically seal welded, hermetic seal weld, hermetic seal welding,” or similar terms shall be construed according to the conventional meaning in the art to be a continuous weld which forms a gas-tight joint between the parts joined by the weld. The term “hermetically sealed” shall be construed to mean a gas-tight seal formed between parts to be joined by seal welding, gasketing, and/or other means.

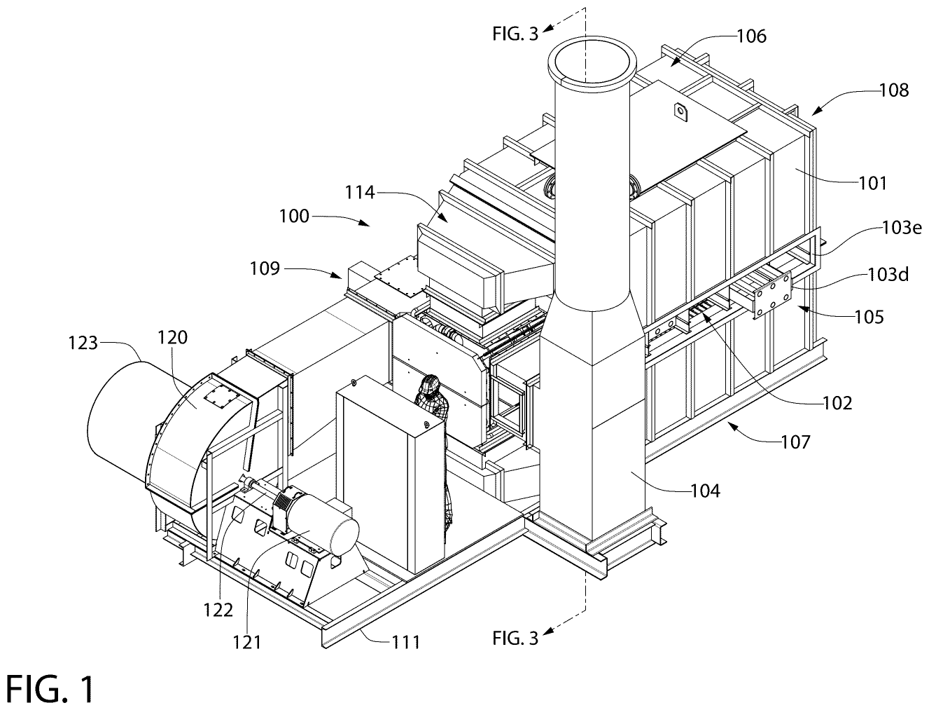

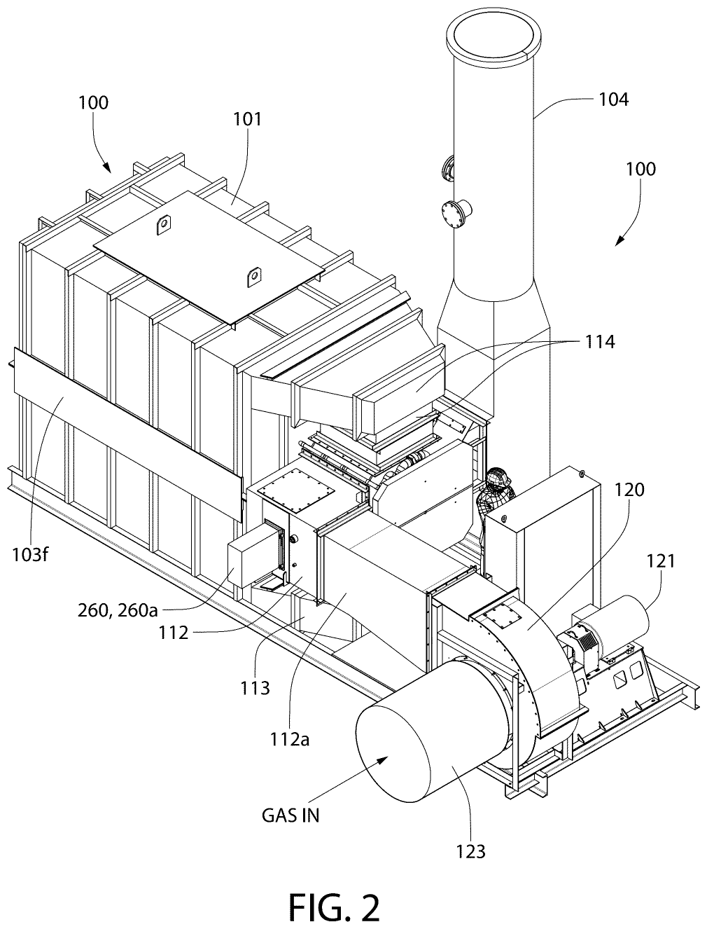

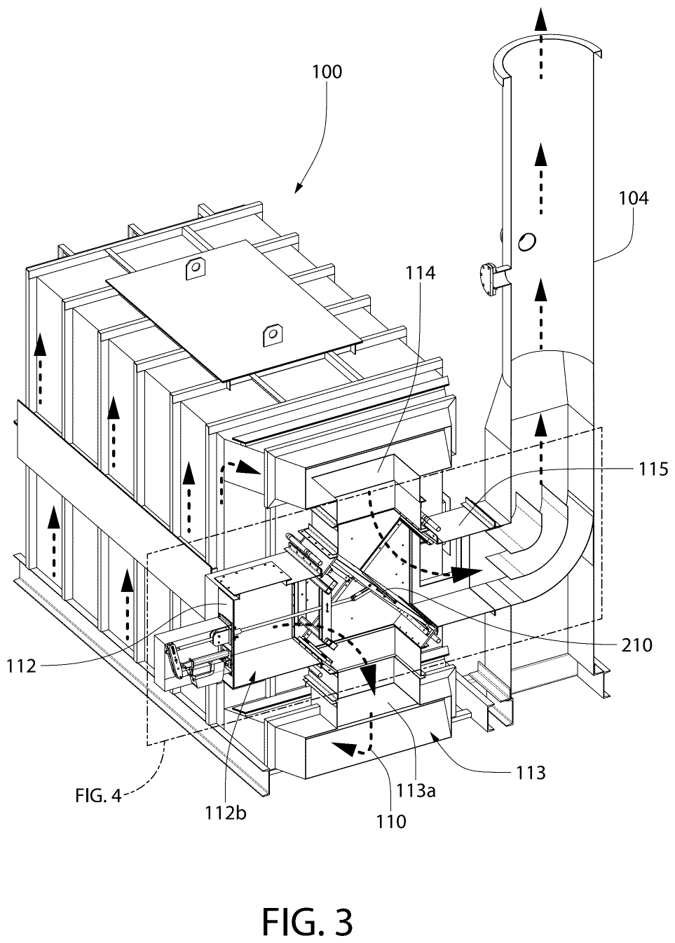

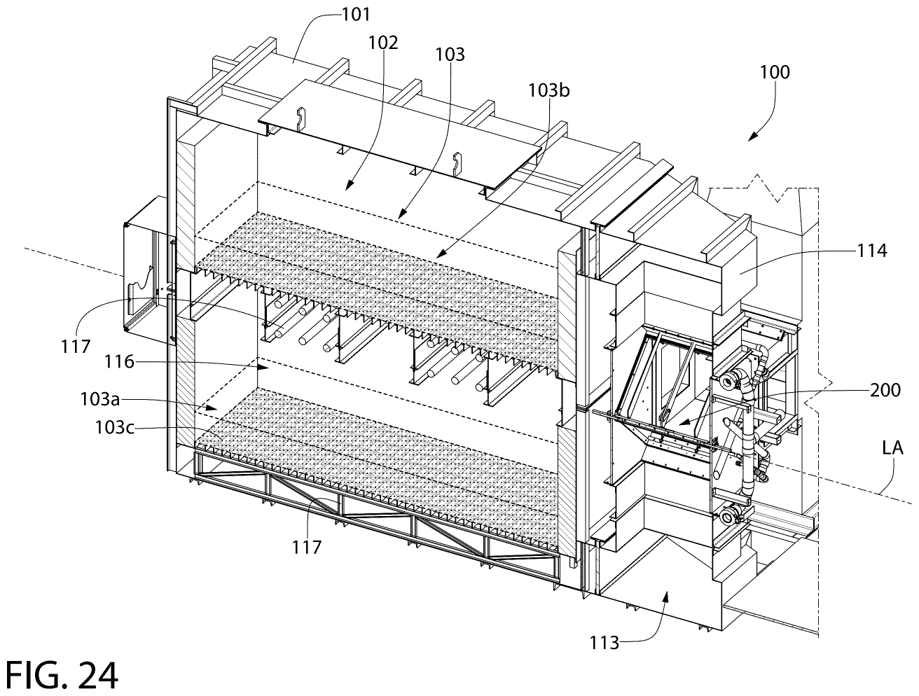

FIGS. 1-4 and 24 show one non-limiting embodiment of an Regenerative Thermal Oxidizer (RTO) incorporating an improved bi-directional gas flow control valve according to the present disclosure. The RTO unit 100 in one exemplary arrangement is an assembly generally including a motor-driven forced draft fan 120, bi-directional gas flow control valve 200, and an outer enclosure 101 defining an internal space 102 comprising a ceramic media bed 103 formed in one embodiment by lower ceramic media bed 103a and an upper ceramic media bed 103b operable to absorb and retain heat from the process gas stream flowing therethrough. In one embodiment, the ceramic media of the beds may be held in a plurality of flow-through removable trays 103d (see, e.g., FIG. 1) supported by upper and lower support grates 103c attached to the RTO enclosure 101 in the interior space 102 as shown in FIG. 24. The trays 103d are slideable into and out of the RTO unit through openings 103e in the sides of the unit for ease of media replacement. Removable panels 103f enclose the openings 103e on each side of the unit when in operation. Normal process gas flow through the ceramic media beds is vertically upwards from bottom to top (see directional gas flow arrows 110, FIG. 3). In other arrangements, the pair of ceramic media beds may be located laterally side-to-side to each other in which case gas flow is in a lateral horizontal direction through the beds. The invention is not limited by the arrangement of the ceramic media beds in the RTO unit enclosure. An exhaust stack 104 is fluidly coupled to the internal space 102 of enclosure 101 to exhaust the treated gas stream to atmosphere. Fan 120 is fluidly coupled to the internal space 102 of the enclosure through the gas flow control valve 200, as further described herein.

The RTO unit enclosure 101 has a generally rectangular cuboid configuration in one embodiment comprising a top 106, bottom 107, first end 108, opposite second end 109, and pair of opposed lateral sides 105. The enclosure may be made of metal panels assembled together by any suitable means such as welding, fasteners, and combinations thereof as some examples of suitable coupling methods.

FIG. 24 is a longitudinal cross-sectional view through a portion of the RTO unit 100 to better show the internal space 102 of enclosure 101 and ceramic media beds 103a, 103b and other features therein. The ceramic media beds are vertically spaced apart to define a combustion zone 116 between the beds which includes a plurality of burners 117 which heats the incoming contaminated process gas stream to the temperature necessary to destroy the VOCs. The lower media bed 103a is elevated above the floor of the enclosure by a plurality of vertical structural supports 117 which allows the process gas to flow beneath the bed.

With continuing reference to FIGS. 1-4 and 22, the fan assembly comprises fan 120 which is driven by electric fan motor 121 through a motor shaft 122 which is coupled to the fan impeller or blade (not shown) inside the fan housing. Fan 120 includes a fan intake duct 123 fluidly coupled to an industrial process which emits process gas containing VOCs to be treated by the RTO unit 200. The fan is configured and operable to draw the process in and discharge the process gas to the unit. The intake duct is coupled to the industrial process by suitable gas ductwork not shown. Any suitable commercially-available forced draft fan of appropriate flow rate and gas pressure output to overcome the frictional resistance to flow through the system and ceramic beds of the RTO unit may be used. In some embodiments, the fan assembly, RTO unit enclosure 101, and stack 104 may be pre-assembled in the factory and coupled to a structural skid 111 for shipment to the installation site.

To direct gas flow through the ceramic media beds of the RTO unit 200 for VOC (volatile organic compound) removal and to reverse gas flow through the ceramic media beds to regenerate the beds as typical in RTO unit operation, several gas ducts are provided including a process gas inlet duct 112 physically and fluidly coupled to the discharge of fan 120 via an extension 112a, an entrance duct 113 to introduce the untreated process gas into the internal space 102 of enclosure 101 to the ceramic media beds for treatment, an exit duct 114 which receives the treated/cleaned process gas stream with reduced VOC concentrations after leaving the RTO unit enclosure 101, and an exhaust duct 115 coupled to the exit duct which receives and discharges the treated gas through exhaust stack 104 to atmosphere. The gas flow control valve 200 is located at the intersection of and fluidly coupled to each these four ducts and operable to selectively control the direction and flow of gas to the ducts for both normal operation and ceramic media regeneration operation as further described herein. The inlet duct 112 defines an inlet plenum 112b located immediately adjacent to the valve 200 in which gas flow changes direction from one horizontal longitudinal direction from the fan 120 to a horizontal lateral direction into the valve. The entrance duct 113 defines an entrance plenum 113a located immediately below the valve 200 from which gas flow changes direction from vertical out of the valve to a horizontal longitudinal direction flowing into the bottom of the internal space 102 of the RTO during normal operation of the RTO unit 200 in which flow is vertically upwards through the ceramic beds in the illustrated embodiment. In the valve arrangement illustrated in FIG. 3, gas flow into and out of the gas flow control valve 200 in always in a direction perpendicular to the longitudinal axis LA of the RTO unit 200 whether the unit is operated in the normal or ceramic bed regeneration modes.

During normal operation of the RTO unit 100, the contaminated process gas stream from fan 102 is directed by the gas flow control valve 200 to enter the entrance duct 113 and flow into the bottom of the RTO unit enclosure 101. The gas changes direction and flows upwards through ceramic beds 103a, 103b as indicated by the directional arrows 110 in FIG. 3 which represents the normal gas flow direction. The gas initially flows through the already warmed lower ceramic media bed 103a to preheat the process gas before entering the combustion zone 116 where it is heated to a temperature high enough to destroy the VOCs. The gas remains in the zone 116 for a predetermined retention period of time until the VOCs are destroyed and converted to water and CO2. The treated gas stream then flows upwards through the upper ceramic media bed 103b which absorbs thermal energy from the gas stream and becomes heated while cooling the gas. The cool treated gas stream flows into exit duct 114 and through the gas flow control valve 200 where the gas is directed into the exhaust duct 115 and stack 104 for discharge to atmosphere.

To next regenerate the ceramic media beds, the direction of the gas stream is now reversed via changing position of the valve 200. The incoming contaminated gas stream now flows through the RTO unit in a reverse direction to that shown by the gas flow arrows 110 in FIG. 3. Valve 200 directs the gas to flow into the top of internal space 102 of the enclosure 101 through the exit duct 114 during the bed regeneration process opposite to the normal gas flow direction previously described above. The gas flows downward through the previously preheated upper ceramic media bed 103b and into the combustion zone 117 to destroy the VOCs in the manner described above. The treated gas continues to flow downwards through the lower ceramic media bed 103a to preheat the lower bed for the next run of process gas which again cools the gas. The treated gas exits the internal space 102 through the entrance duct 113 and flows into valve 200. The valve now directs the treated gas stream into the exhaust duct 115 and stack 104 for discharge to atmosphere.

The foregoing normal gas flow direction and treatment is then repeated and so on to each time preheat one of the ceramic media beds 103a, 103b with the treated gas. This cyclic process represents conventional operation of an RTO unit which is well understood in the art without further undue elaboration necessary.

According to one aspect of the invention, an improved bi-directional gas flow control valve 200 for a Regenerative Thermal Oxidizer (RTO) is disclosed herein having a design which reduces the most common issues experienced with sealing a high cycling valve to minimize gas leakage. A single blade, four-way valve advantageously replaces two or four valves of the butterfly or poppet style of past RTO units. The single valve is operable to reverse the flow through two heat recovery ceramic beds thus reducing the number of actuation systems required. The single valve is more compact than using multiple individual valves of prior designs to achieve the same gas flow control thereby providing the operational and maintenance benefits noted before.

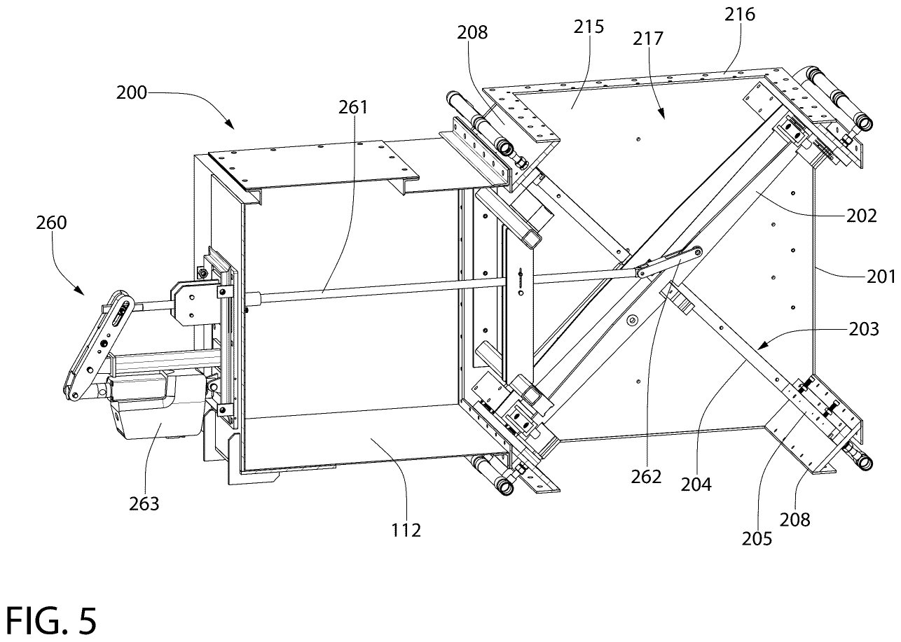

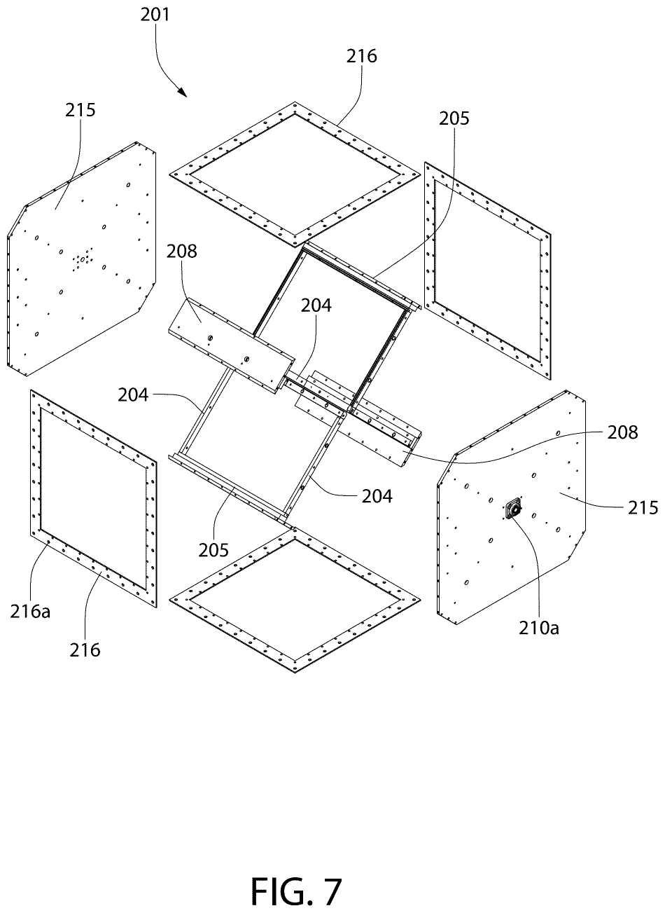

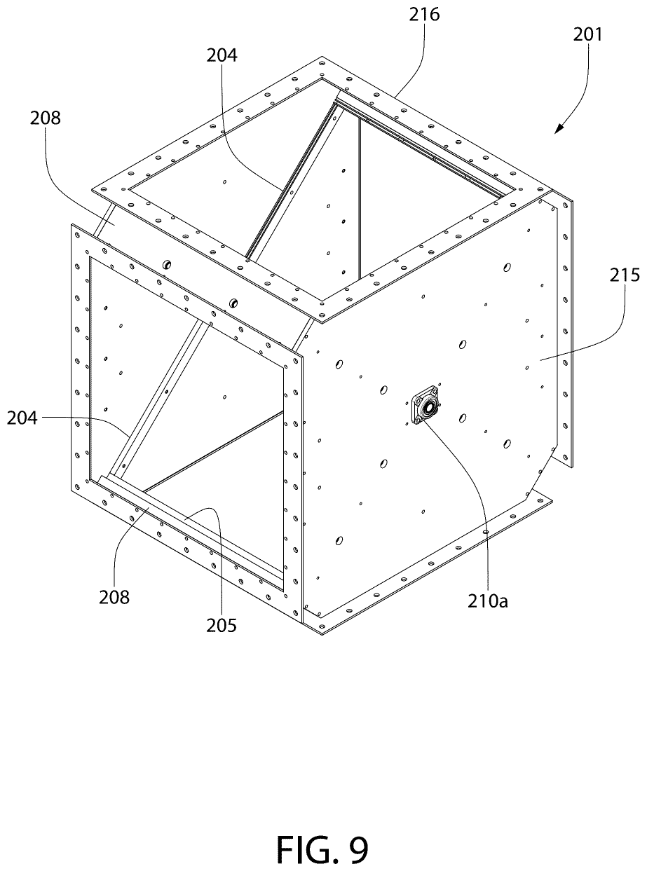

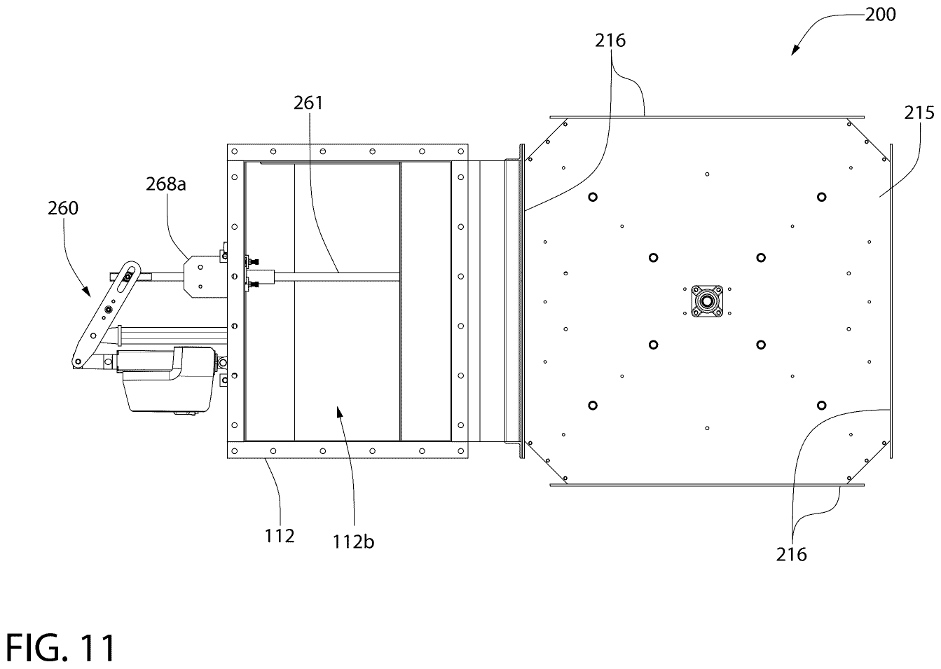

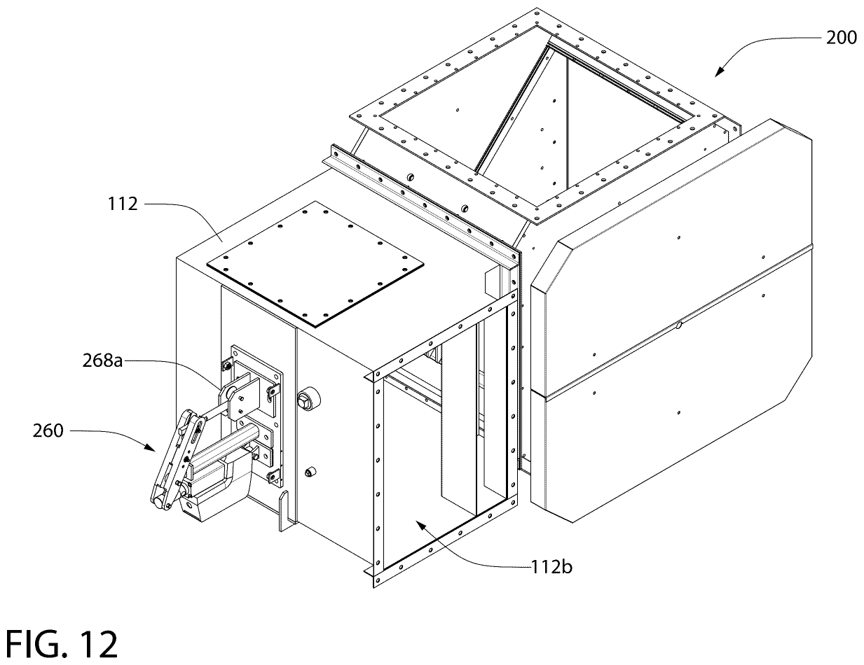

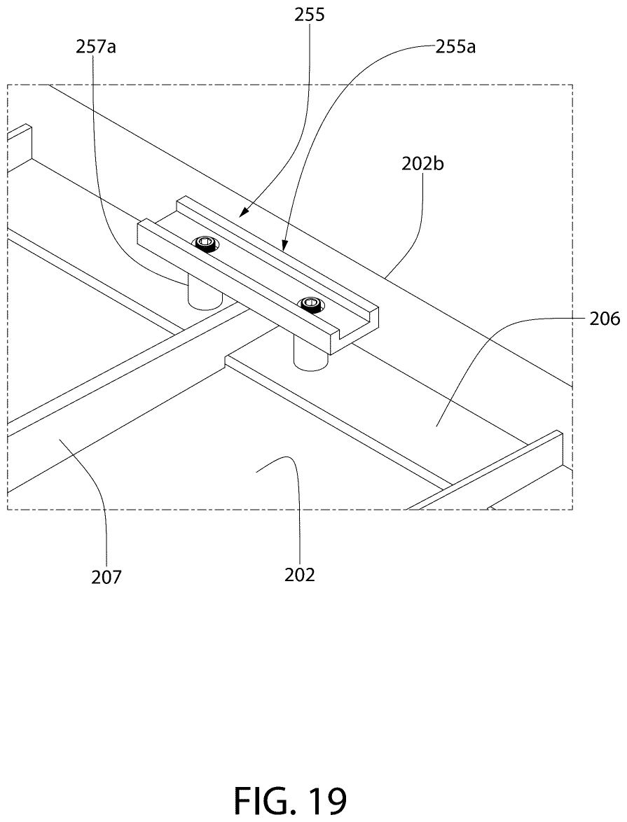

FIGS. 5-21 show various features of the RTO bi-directional gas flow control valve 200 according to the present disclosure in greater detail. The valve generally includes a valve housing 201 which pivotably supports the damper blade 202 therein and a plurality of gas seals formed by seat plates arranged to collectively define the valve seat 203. Housing 201 defines an internal cavity 217 in which the damper blade is pivotably disposed. The seat plates are fixedly coupled to valve housing 201 and include lateral seat plates 204 which releasably seal the lateral sides 202a of the damper blade 202 to the housing, and diagonal end seat plates 205 which releasably seal the opposing ends 202b of the blade to the housing, as further described herein (see, e.g., FIG. 7 and others). When the blade is in either operating positions, the seat plates 204 and 205 effectively seal the entire perimeter and periphery of the blade body to the interior of valve housing 201 to eliminate or minimize leakage past the seals between the two gas flow paths provided by the valve. In the non-limiting illustrated embodiment, the valve housing 201 is configured for mounting at the junction of a plurality of gas flow ducts associated with the RTO unit. The bi-directional gas flow control valve 200 may be a 4-way valve coupled to four ducts 112, 113, 114, and 115 of the RTO unit noted above at the 4-way junction or intersection of the ducts as best shown in FIG. 3. Accordingly, valve 200 controls the flow of contaminated and treated gas streams into or out of the four ducts depending on the position of the valve (i.e. damper blade 202).

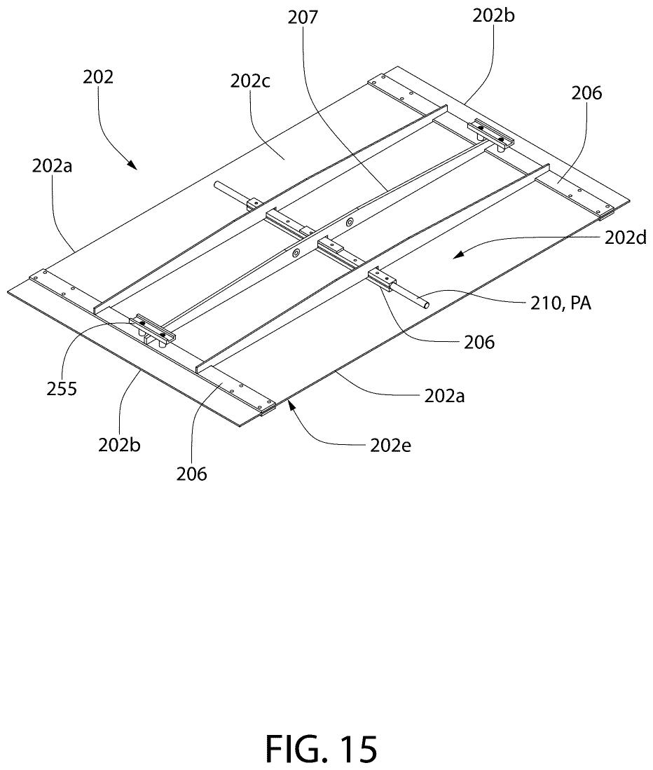

The damper blade 202 may have a rectilinear shaped flat body 202c such as rectangular as shown in one embodiment (see, e.g., FIG. 15 showing the blade in isolation). The blade comprises a pair of opposing lateral sides 202a and a pair of opposing ends 202b extending between the sides. The blade 202 further defines a pair of major surfaces 202d, 202e on opposite faces of the blade body. The term “major surfaces” connotes that these two surfaces have a substantially larger surface area than all other surfaces on the damper blade. Since the blade is relatively long and may exceed 6 feet in length in some embodiments (measured along the lateral sides), one or more elongated structural bracing members 207 (“strongbacks”) are provided which extend along a majority of the length of the blade to reinforce and stiffen the structure for better resisting deflection by the flowing pressurized gas stream which impinges the major surfaces of the blade. The bracing members 207 may be formed of elongated flat metal plates in the shape of ribs which are oriented perpendicularly to the ends 202b of blade body 202c and parallel to sides 202a in one embodiment. The bracing members may be welded to one of the major surfaces 202d of the blade, or as illustrated may be detachably bolted to the blade body via laterally elongated mounting plates 206 at the blade ends, or via a combination of both. At least two or more laterally spaced apart bracing members may be provided in one non-limiting embodiment such as three for example as shown; however, other numbers of bracing members may be provided.

To mount the mounting plates 206 in turn to the blade body 201, the longitudinally spaced apart and transversely (e.g., laterally) extending flat mounting plates may be permanently or detachably attached to the blade body. One mounting plate may be located at the center of the shown near or at the blade shaft. Other arrangements of the mounting plates may be used. The bracing members 207 may be a fixedly or detachably coupled to the mounting plates via welding or fasteners. Bracing members 207 are perpendicularly oriented to the mounting plates 206 in one embodiment. Shims may be inserted between the mounting plates and blade body as needed to adjust for out-of-plane curvature or bowed of the long blade body which may result from rolling and fabrication of the metal plate of the blade. The shims allow adjustments to be made after fabrication if needed which enhances forming a gas-resistant seal at the peripheral regions of the blade.

The blade shaft 210 is transversely mounted to the blade and extends laterally from side to side as shown with some projection on each end beyond the blade sides for coupling to suitable rotational support bearings 210a which can be attached to the side plates of the valve housing (see, e.g., FIG. 7). The shaft is located midway between the ends 202b of the blade 202 to provide a rotationally balanced blade. The blade (body 202c and bracing members 207) may be made of a suitable metal, such as steel for strength and rigidity. Other suitable metals including aluminum of suitable thickness may be used as appropriate.

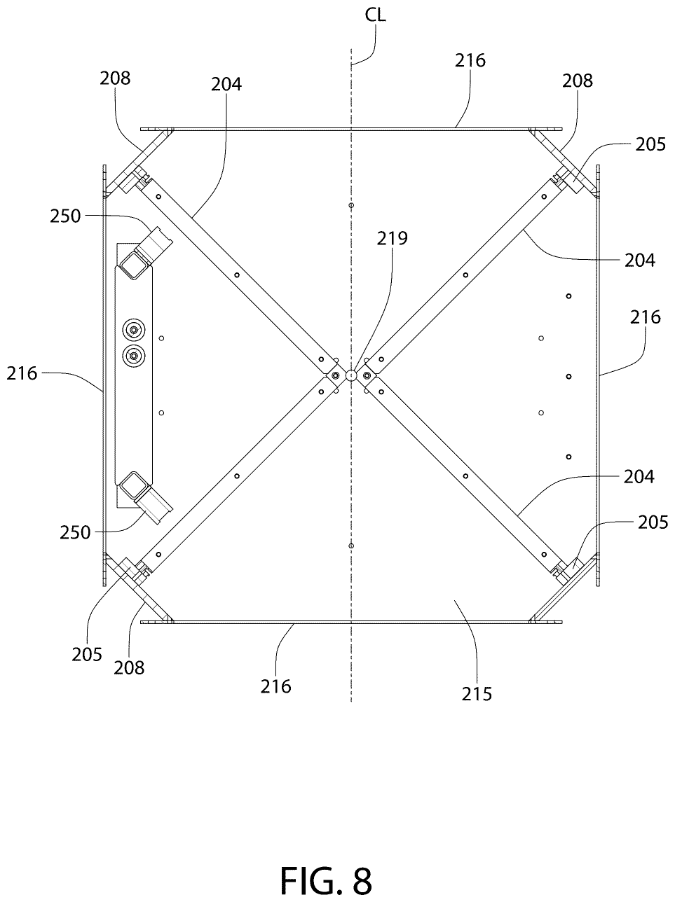

The valve housing 201 comprises a pair of opposed lateral side plates 215 and four flange plates 216 arranged at the opposite vertical ends and the horizontal top and bottom of the side plates as shown in FIG. 7 which is an exploded view of the valve housing. The flange plates 216 includes plural fastener openings 216a for coupling the valve to the RTO unit housing associated ductwork via threaded fasteners in one embodiment. The flange plates may be rectilinear shaped (e.g., square or rectangular) as shown to match the gas ducts of the RTO unit having a complementary configured rectilinear cross-sectional shape. The four corners of the side plates may be chamfered at a 45 degree angle in the non-limiting illustrated embodiment defining laterally elongated openings at each of the four top and bottom corners of valve housing 201 which are closed by diagonal end seat support plates 208 at the diagonal positions of the valve housing (see, e.g., FIGS. 5 and 8). The diagonal end seat plates 205 which form the fluid seal are coupled in turn to the inside of the diagonal end seat support plates 208. The end seat support plates 208 may be attached to the side plates 215 and flange plates 216 of the valve housing 201 via any suitable method or combination of methods used in the art such as seal welding in one embodiment to form a leak-resistant valve housing at the four corner joints.

The gas flow control valve 200 includes both lateral seals to movably and releasably seal the opposing lateral sides 202a of the damper blade 202 to the valve housing 201, and diagonal end seals to movably and releasably seal the opposing ends of the blade to the valve housing which are acted upon by the electromagnetic clamps, as further described herein. The term “diagonal” refers to the fact that the horizontally and laterally extending end seals are located at the diagonal positions of the valve housing at each of the top two corners and bottom two corners (see, e.g., FIG. 8).

Referring now to FIGS. 5-10, the lateral pressure seals are formed by lateral seat plates 204 and the diagonal end seals are formed by diagonal end seat plates 205. All of the seat plates are fixedly coupled to the valve housing or portions thereof described herein either detachably via fasteners or permanently via welding. The combination of lateral and end seat plates 204, 205 collectively define the “valve seat” 218 referred to herein which comprises a pair of open frame-shaped structures 218a, 218b disposed 90 degrees to each other to seal the damper blade 202 in both the normal and regenerating operating positions when the blade is pivotably toggled back and forth therebetween during operation of the valve. The damper blade correspondingly rotates 90 degrees between both operating positions.

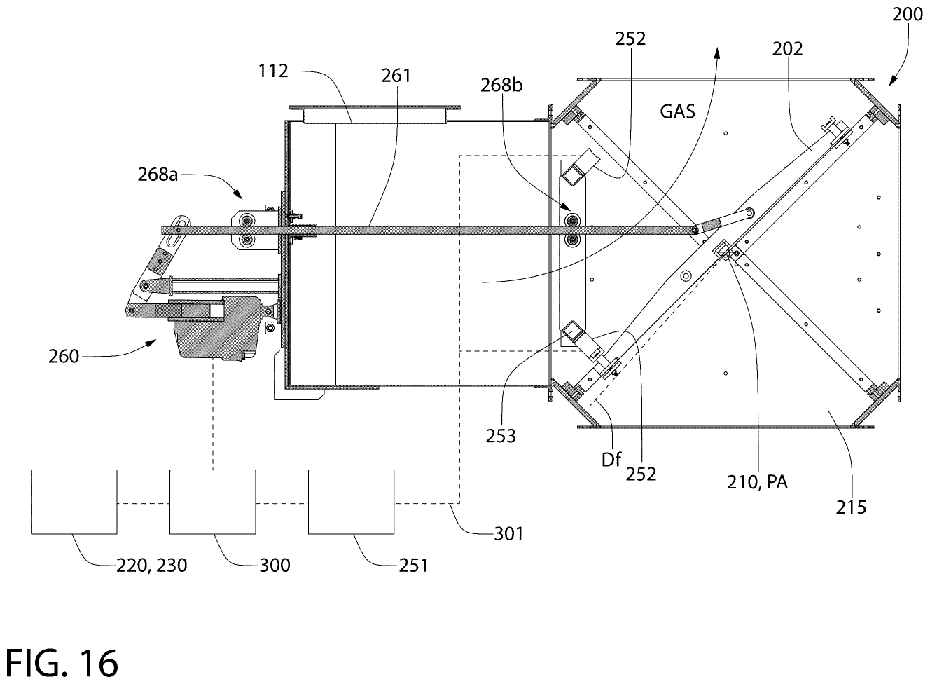

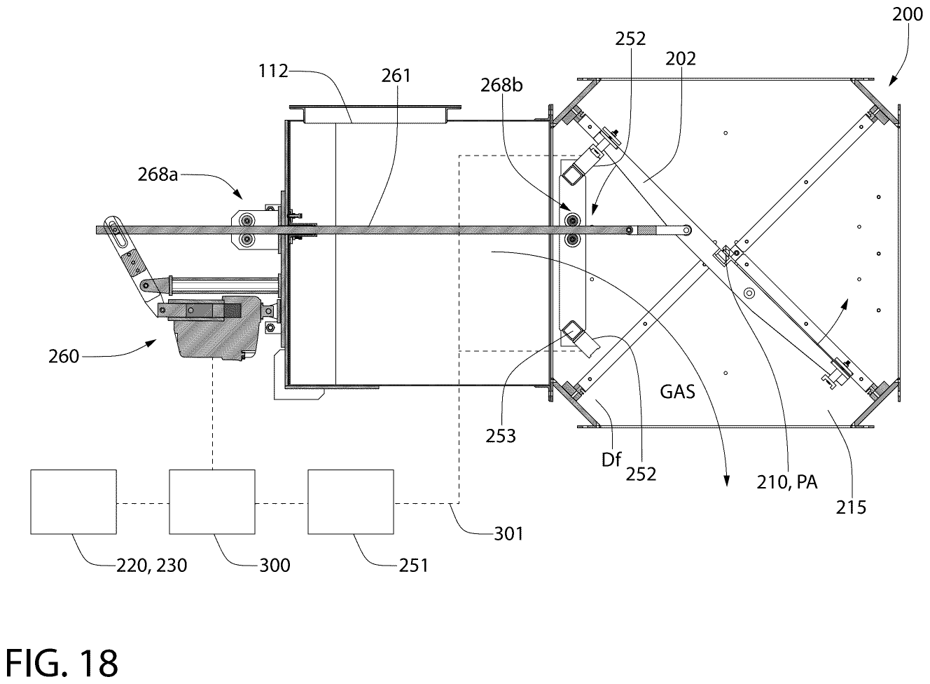

Four lateral seat plates 204 are fixedly coupled to each side plate 215 of the housing inside the internal cavity 217 of the gas flow control valve 200 defined by the valve housing 201. Each lateral seat plate defines a sealing surface which selectively and abuttingly engages the flat peripheral side portions of the major surfaces 202d, 202e of the damper blade 202 along lateral sides 202a to provide the gas seal. The lateral seat plates 204 may be arranged in an “X” pattern as shown on each housing side plate 215 so that a cooperating pair of lateral seat plates on each lateral side of the damper blade actively fluidly seal the lateral sides of the blade against pressure and gas leakage in each of the two operating positions of the valve (see, e.g., FIGS. 16 and 18). A centrally located gap is formed between the top and bottom angled pairs of lateral seat plates on each side of the valve vertical centerline CL (arranged in a V-shaped pattern) to provide space for the damper blade shaft to extend through openings 219 in the side plates (see, e.g., FIG. 8). Centerline CL divides the blade for reference purposes into two halves (e.g., upper half and lower half). The blade shaft 210 defines the pivot axis PA of the blade.

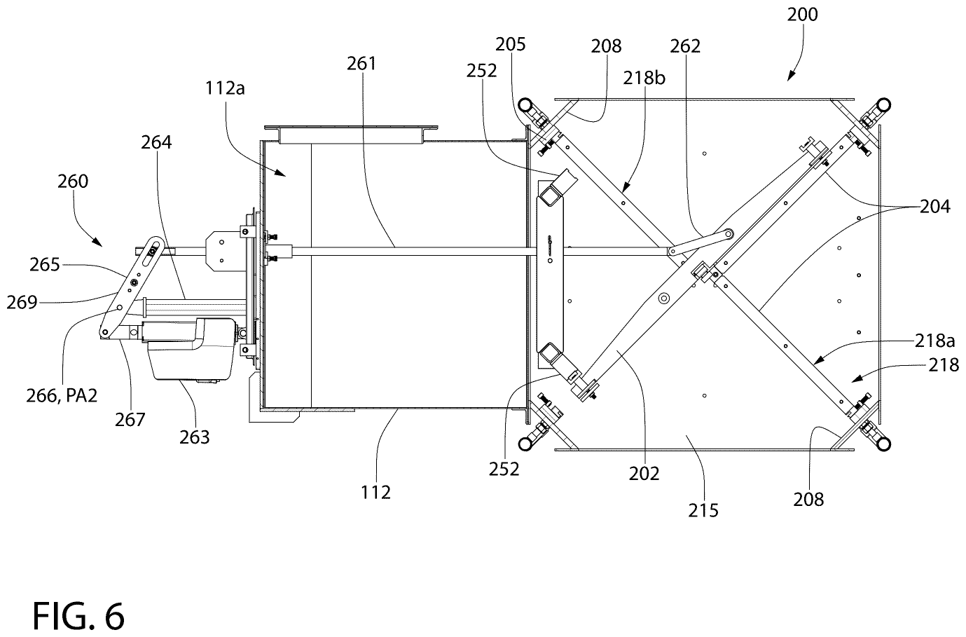

With continuing reference to FIGS. 5-10, the diagonal end seat plates 205 previously described herein may be detachably coupled to the diagonal end seat support plates 208 at the four corners of the valve housing to allow the seats to be easily replaced if needed. Each end seat plate 205 defines a sealing surface which selectively and abuttingly engages the flat peripheral end portions of the major surfaces 202d, 202e of the damper blade 202 to provide the gas seal as the valve is operated. When the damper blade is in its two operating positions, the blade sealingly engages one diagonal pair of end seat plates 205 of the four end seat plates (see, e.g., FIG. 6).

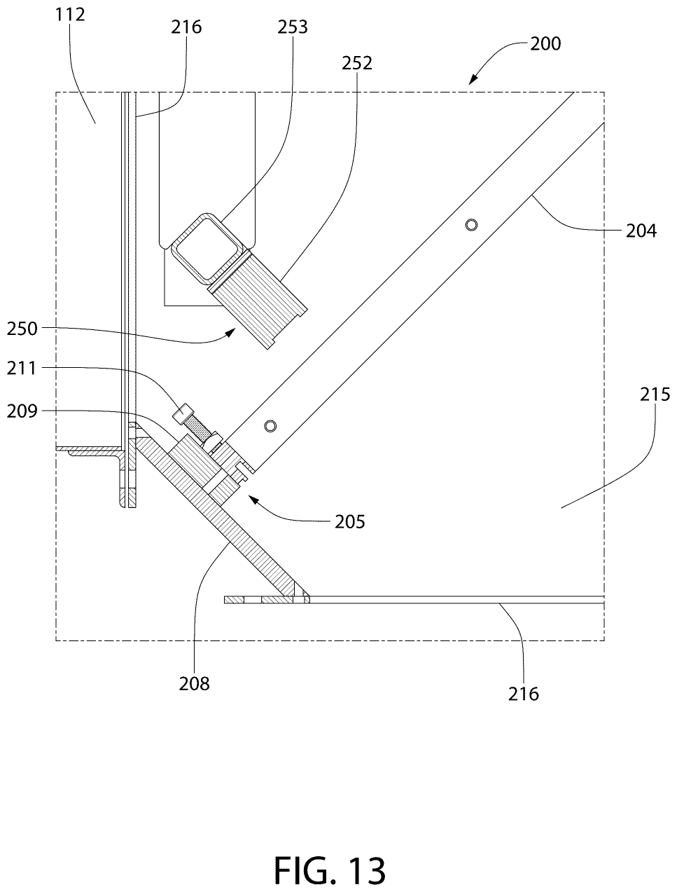

The end seat plates 205 may provided with adjustment screws 211 which allow the position of the sealing surfaces defined by the plates to be adjusted relative to the damper blade 202 in order to form a good leakage resistant seal. The adjustment screws may extend through threaded through holes in the seat support blocks 209 affixed to the diagonal end seat support plates 208 to engage the end seat plates 205 in order to adjust their position relative to the blade ends (see, e.g., FIG. 13).

Detachable mounting of the lateral and end seat plates 204, 205 to the valve housing 201 allows interchangeable provision of seating styles and materials including for example without limitation soft Viton or elastomer seating materials, or in the non-limiting embodiment shown, an all metal seat with robustly-sized internal air passage ways to allow pressurized clean seal air to fill an outwardly channel in the seat which can eliminate process gas leaking past the valve. Advantageously, the detachable mounting of the seats allows the type and materials of the seat to be customized for each RTO unit installation to match the type and properties of the gas emission stream encountered to achieve optimum gas sealing. In other possible embodiments, however the lateral seat plates and/or end seat plates can be permanently attached to the valve housing via welding if desired.

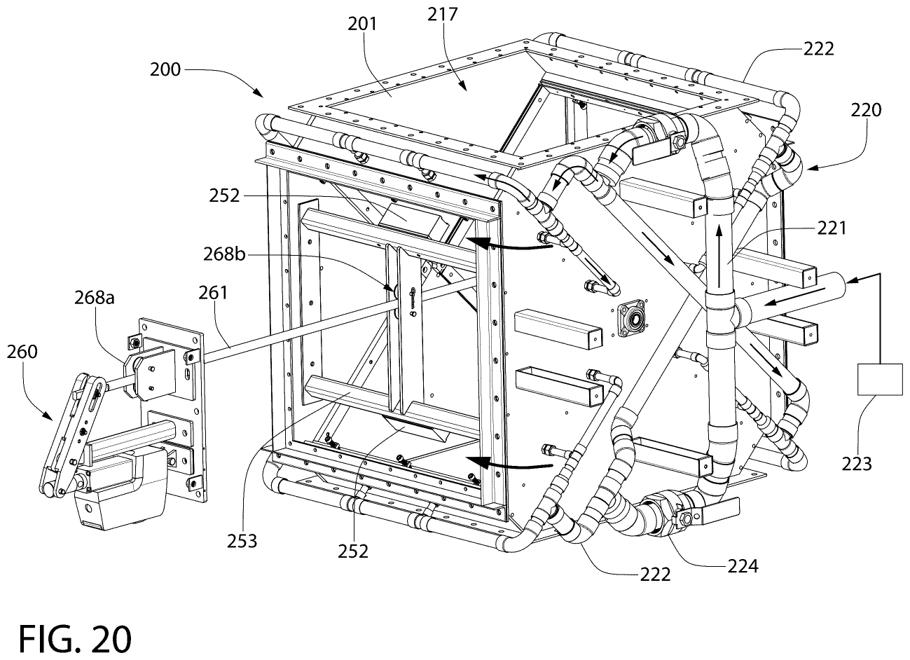

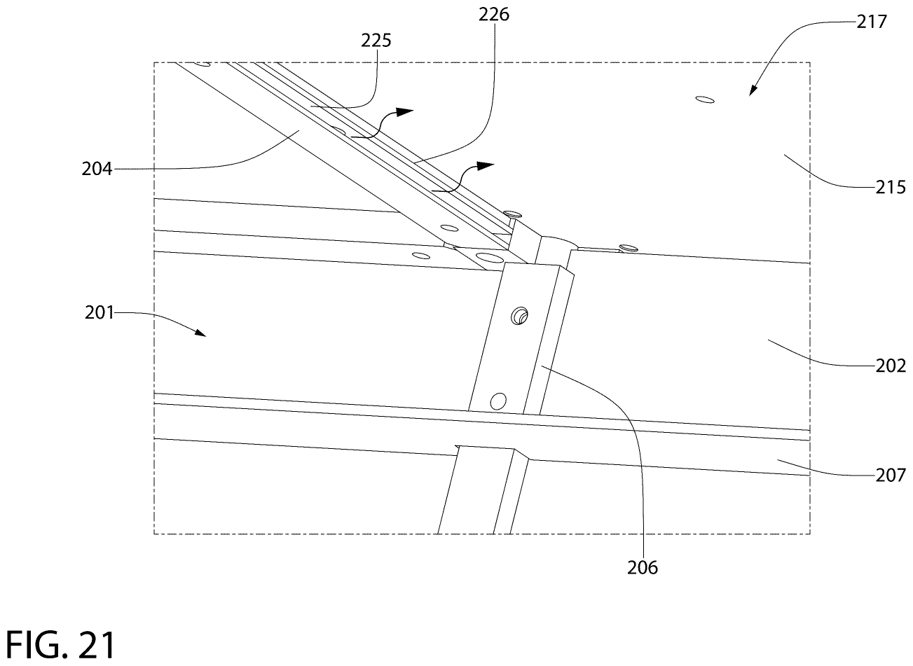

FIGS. 20-21 show aspects of the valve seat seal air system 220 including the seal air distribution manifold 221 supported by valve housing 201. The manifold distributes seal air from a pressurized air source 223 to each of the lateral and diagonal end seat plates 204, 205 previously described herein via a plurality of air supply branches 222. The seat plates 204, 205 are each provided with elongated internal air passageways or channels 225 defining discharge openings 226 extending along the entire lengths of the plates which discharge pressurized seal air into internal cavity 217 of the valve housing 201. As an example, FIG. 21 shows the channels and discharge openings for a portion of one of the lateral seat plates 204 affixed to one side plate 215 of the valve. A similar configuration is provided for the other lateral seat plates 204 and both end seat plates 205. The manifold and air supply branches may be formed by suitable flow conduits such as piping and/or tubing. One or more seal air control valves 224 which can be altered between closed, open, and throttled intermediate positions control the flow of pressured air to the seat plates 204, 205 which flows into the internal cavity 217 of the valve housing 201. The valves may be operably coupled to the controller which controls the position of the valves and flow of air. A commercially-available fan or air compressor may be used as the source 223 of pressurized air.

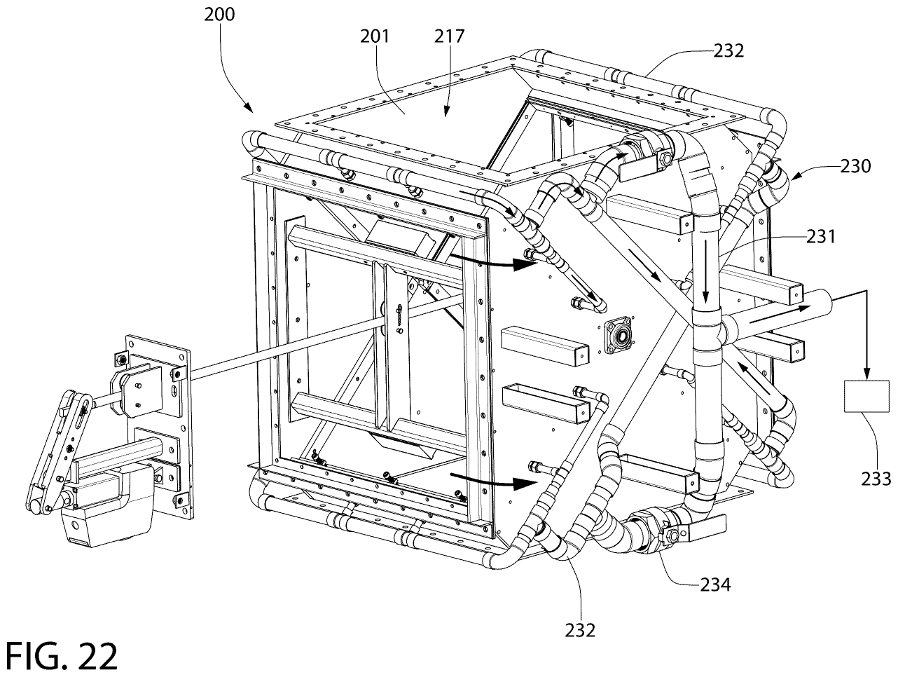

FIG. 22 shows an alternative embodiment of a negative pressure or vacuum sealing system 230 for enhancing valve sealing at the lateral and end sealing locations formed by lateral and diagonal end seat plates 204, 205. The valve sealing in this case uses high negative pressure to vacuum away or draw any potential leakage at the lateral and end seat plates outwards from the internal cavity 217 of the valve housing 201. The extracted gas is redirected back to the RTO inlet duct to be treated in the ceramic media beds with the incoming process gas stream from the plant process. The vacuum sealing system includes a vacuum manifold 231 supported by the valve housing 201 which is fluidly coupled via a plurality of vacuum suction branches 232 to each of the lateral and end seat plates 204, 205 provided with the same type internal air channels 225 which in this case act to draw gas into the channels from the internal cavity of the valve housing through the same openings 226 in the seat plates. The manifold 231 and suction branches 232 may be formed by suitable flow conduits such as piping and/or tubing. The gas flow however is in a reverse direction to the pressurized seal air system described above. A commercially-available vacuum pump may be used as the vacuum source 233 which is fluidly coupled to the manifold 231. One or more vacuum control valves 234 which can be altered between closed, open, and throttled intermediate positions control the level of vacuum applied to the valve seats 204, 205. The valves may be operably coupled to the controller 300 which controls the position of the valves and on/off application and negative pressure level of the vacuum applied to the valve seats.

The proposed gas flow control valve arrangement and drive system further improves the valve sealing in simple traditional on-off butterfly type valve operation utilizing a single blade by employing a pair of unique electromagnetic clamps 250 disposed proximate to the blade end sealing points defined by the diagonal end seat plates 205 which mate with the blade end portions as shown.

Referring generally to FIGS. 13-19, each electromagnetic clamp 250 is formed by an electromagnet 252 electrically coupled to an electric power source 251 operably under control of programmable controller 300 (see, e.g., FIG. 16). One electromagnet 250 each is coupled to the valve housing 201 at top and bottom positions inside valve internal cavity 217 to alternatingly engage each of the two ends of the damper blade when the blade is in either of its two operations positions. Each electromagnet 252 is detachably coupled to a transversely/laterally elongated electromagnet support member 253 attached to the valve housing such as to each of the opposing side plates 215. Suitable metal structural members such as structural shapes (e.g., angles, C-channels, I-beams, etc.) including tubes as shown may be used. The ends of the support members 253 are fixedly coupled to the valve housing side plates 215 via welding or fasteners. In one embodiment, a commercially-available DC high temperature parallel pole electromagnet may be used which has a generally rectangular cuboid configuration. Other shaped electromagnets could be used if appropriate. The electromagnets 252 are each configured to abuttingly engage an electromagnet target 255 disposed on end portions of the damper blade 202 proximate to the ends 202b of the blade, which is further described herein.

The electromagnetic clamps 250 eliminates flow leakage past and through the gas seal on the half of the blade 202 which is acted upon by the gas pressure in a direction counter or opposite to the force required to maintain contact between the mating sealing surfaces at the valve seat. Gas pressure and flow related forces on the damper blade 202 generated by the pressurized flowing process gas stream can cause the blade to bow and/or deflect away from the valve seat (particularly end seat plates 205 where leakage would be most acute) on this half of the damper blade resulting in flow leakage past the seals. The electromagnetic clamps comprising electromagnets 252 when energized via application of electric current advantageously draw the ends of the blade tightly against the diagonal end seat plates 205 to enhance a positive gas flow seal between the damper blade 202 and valve seat.

FIG. 16 illustrates the gas seal problem noted above and advantage of the electromagnetic clamps 250. The damper blade 202 of the gas flow control valve 200 (e.g., butterfly type valve with central pivot axis PA defined by blade shaft 210) is acted upon by the gas pressure from the flowing process gas emission stream (represented by the gas directional arrow shown) which forces one end 205 portion of the damper blade against the valve seat plates 204, 205 on one half of the blade (upper half in this figure) to form a good leak-resistant seal above the blade shaft 210 and pivot axis PA. However, the other half of the blade (lower half in this figure) of the blade is forced and deflected away from the valve seat plates 204, 205 at the other end 205 portion of the blade resulting in leakage past the seal (blade deflection under pressure schematically represented by the exaggerated dashed bent deflection line Df).

To produce a sufficient pressure between the blade and the seat to eliminate gaps and leakage at the valve seat, which can be in the range of 1 to 5 lbs. per square inch, a significant torque would need to be applied to the centered valve blade shaft of a traditional butterfly damper blade by the motor and those forces transmitted from the shaft all the way through the blade to its ends at the diagonal valve seat. The moment arm created by the length of the damper blade (which can exceed 6 feet in some embodiments) exacerbates the problem as the length of the blade increases. The valve motor must therefore provide sufficient torque to both actuate the blade between its two operating positions (normal process flow and regeneration flow) as well as providing the additional torque to maintain the flow seal at the valve seat on the leakage prone half of the blade noted above. This is an inefficient sealing mechanism which increases the motor torque requirements and hence power consumption and concomitantly energy costs as well in addition to putting severe service duty on the motor which can decrease motor life.

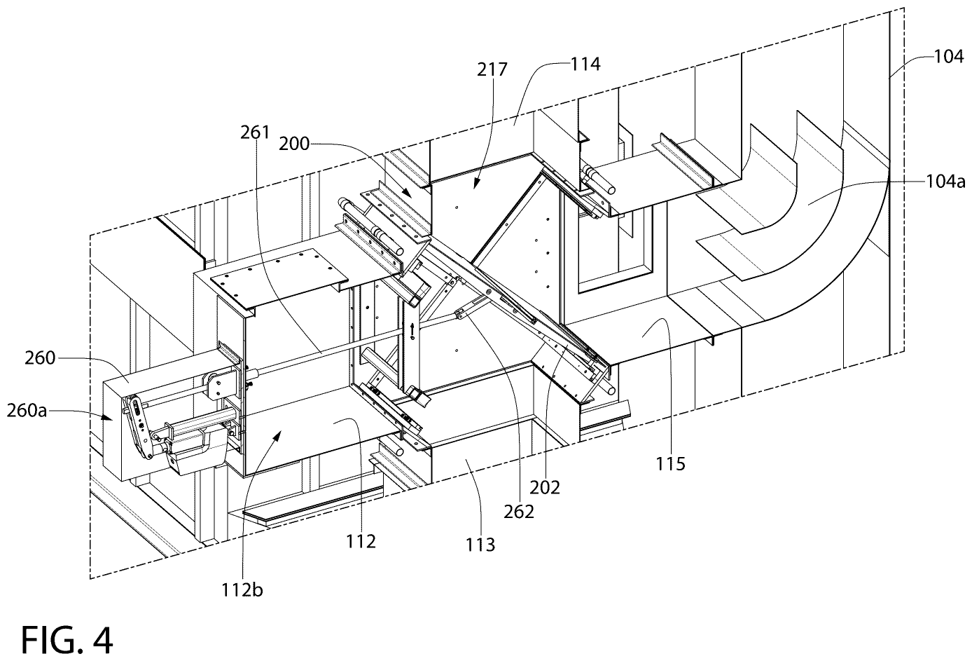

By advantageously using valve seats which cooperate with a proximally located electromagnetic clamp 250 as disclosed herein to maintain a positive gas flow seal at the problematic end portion of the damper blade most affected by the gas flow as noted above, the valve actuator further described herein is required to generate only enough torque to move the damper blade shaft between its normal and regeneration operating positions. The electromagnetic clamps 250 provided the gas sealing force on the valve seat in lieu of a motor acting on the blade shaft as in prior butterfly-type damper valve designs. This advantageously reduces the valve size and power consumption requirements. In addition, the motor torque requirements can be further reduced by actuating the blade directly from the blade actuator as disclosed elsewhere herein in lieu of torqueing the centered blade shaft as in traditional butterfly valve designs. As shown for example in FIGS. 4-6, 10, and 16-18, an actuator 260 comprising an elongated operating rod 261 couples the damper blade 202 directly to the actuator through the valve housing 201 in lieu of connecting a motor to the damper blade shaft as in traditional past designs. This benefit can be maximized by moving the point of the actuation force produced by the motor-driven actuator 260 further out form the pivot axis PA moving towards the perimeter and peripheral region of the blade, such as for example on one half of the blade that is being deflected away from the seat by the gas pressure as previously described herein.

In addition to providing a positive gas seal at the diagonal-located end seat plates 205 where gas leakage past the seal is most problematic (the end portions of the blade being farthest from the pivot axis PA), it bears noting that the electromagnetic clamps 250 also assist with maintaining contact of and sealing the very end regions of the lateral seat plates 204 proximate to each of the end seat plates) with the blade body.

To eliminate leakage past the diagonal end seats 205 most prone to gas bypass leakage as previously described herein, the electromagnetic clamps 250 in some embodiments need only be provided in conjunction with those valve end seats 205 for the half of the damper blade acted on by and first encountering the incoming pressurized gas stream to valve 200 which can deflect and force the blade away from its seat. For the valve arrangement disclosed herein, for example only two electromagnetic clamps 250 are required (e.g., top and bottom seals on the left side of the valve and pivot axis PA in FIG. 16). However, in other embodiments, electromagnetic clamps can be provided for all four diagonal seals if desired and necessary to promote a positive gas seal. This may be dependent in part on the length of the damper blade since longer blades are more difficult to seal satisfactorily.

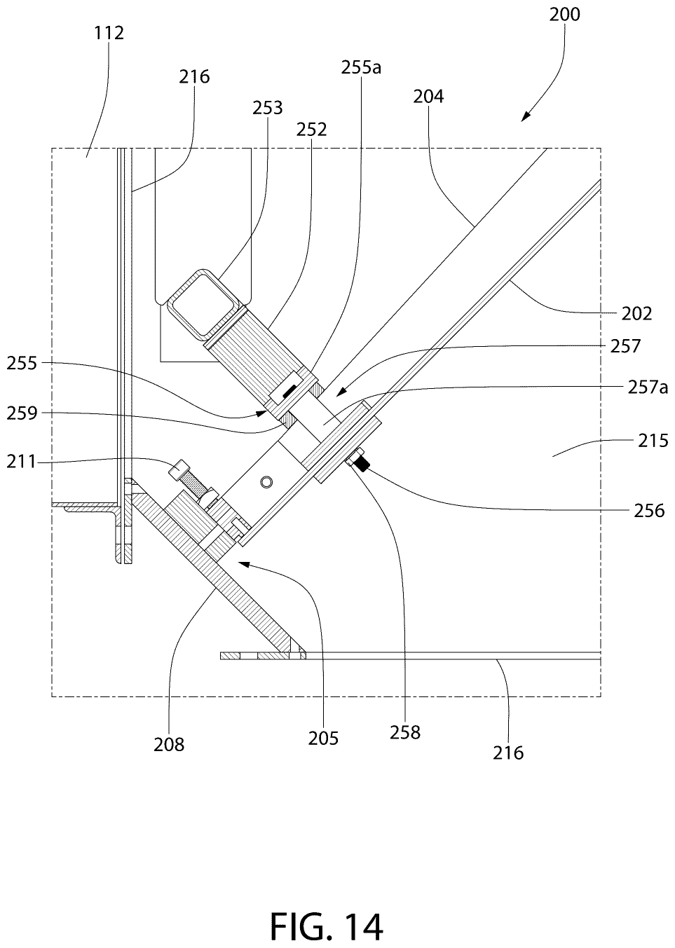

As part of the electromagnetic clamp system, the damper blade 202 in a preferred but non-limiting embodiment includes a pair of electromagnet targets 255. Referring at present to FIGS. 13-19, each target is are selectively engageable with a respective electromagnet 252 as the blade is pivotably moved and rotated between its normal and regeneration operating positions in a toggle-type action (best shown in FIG. 14). The position of the targets 255 on the damper blade 202 are coordinated with location of the electromagnets 252 so that each target will contact and be magnetically attracted to its respective electromagnet as required. The targets may be formed of any suitable material which is attracted by an applied magnetic force. In one embodiment, the targets may be formed of a ferrous metal such as steel (e.g., carbon steel, ferritic stainless steel, etc.) which may detachably coupled to the opposite end portions of the blade body 201 in one embodiment such as for example via threaded fasteners 256 or other suitable coupling means. In other possible embodiments, the targets may be formed of a permanent magnet.

In one embodiment, each electromagnet target assembly includes a non-ferrous (i.e. non-magnetizable) isolation member 257 such as without limitation a pair of standoffs 257a and a target 255. The targets 255 may comprise an elongated generally flat target plate 255a configured to form a flat-to-flat interface with the rectangular cuboid body of the electromagnet 252 (see, e.g., FIG. 16). When formed of ferrous material, the target plate may be C-shaped in some embodiments to accept the head of the fastener 256 as best shown in FIG. 14; however, a completely flat plate or plates of other configurations may be used. If permanent magnets are used for targets, the magnets may have a rectangular cuboid body as well. The standoffs 257a may be formed by hollow tubular sleeves in one embodiment disposed between the blade bracing member mounting plates and bottom surface of the target plate. The target mounting fasteners 256 are inserted and extend through in turn the target plate 255a, standoffs 257a (e.g., sleeves), blade body 202c, and finally the mounting plate 206 on the blade. Fasteners 256 may pass completely through openings in the mounting plates to the opposite major surface of the blade where the fasteners can be secured in place via threaded nuts 258 (see, e.g., FIG. 14). This is just one non-limiting example of a coupling arrangement and assembly for attaching the targets to the damper blade 202. Other suitable detachable arrangements for coupling the targets to the blade may be used.

The use of an electromagnet 252 for pulling the damper blade 202 tightly against the end seats (i.e. seat plates 205) of the gas flow control valve 202 can potentially magnetize the metallic blade, thereby attracting metal filings left over from machining or from other sources which could potentially interfere with achieving a good leak-resistant seal at the end seats. To prevent this situation, the electromagnet targets 255 are preferably spaced apart from the body of the damper blade by non-ferrous isolation members 257 (e.g., standoffs) for this purpose which are disposed between the blade body and target plates as shown in FIG. 14. Both the standoffs and optionally but preferably the target mounting fasteners 256 can be formed of a non-ferrous metallic or non-metallic material to magnetically isolate the blade from the electromagnet 255 and prevent the damper blade 202 itself from becoming magnetized. Suitable stainless steels such as austenitic stainless steel may be used as the non-ferrous metallic material in one embodiment as an example; however, other non-ferrous and non-magnetizable metals or plastics may be used as appropriate for the standoffs and fasteners (the latter being preferably formed of non-ferrous metal).

In an alternative embodiment, fixed (permanent) magnets may be integrated into the target for the electromagnet to enhance and strengthen the attraction force therebetween if additional clamping force is needed to maintain good contact between the blade and end seat plates 205 on the valve housing 201.

In addition, in lieu of just de-energizing the electromagnet at the end seat plate 205 of the valve 202 to be vacated when changing damper blade position, the electric polarity of the electric current supplied to the electromagnet to energize the electromagnet can be reversed via the programmable controller 300 to create an opposing magnetic force which repels the target-mounted fixed magnet, thereby pushing the respective end portion of the blade off the valve seat. This provides assistance to help move and drive the blade quickly to the next blade operating position to be assumed. Whereas de-energizing the electromagnet releases the damper blade from the present operating position, changing polarity of electric current to the electromagnet therefore repels the damper blade to drive the damper blade towards the next operating position.

The controller 300 is thus operably coupled to and controls the source of electric power and polarity of electric current supplied to the electromagnets 252 of the electromagnetic clamps 250 for the foregoing purposes and operation of the gas flow control valve. Accordingly, the controller controls both the valve actuator 260 for changing valve position, and the sequence and selective energization/de-energization of the electromagnets (including optionally changing electric polarity) in coordination with a change in valve position. These foregoing factors all advantageously result in improving position valve gas sealing and positional changes of the damper blade which occurs frequently with such bi-directional gas flow control valve when used in RTO applications.

In applications where there is sticky or oily condensables in the gas emission stream to be treated in the RTO, an electric strip heater 259 can optionally be mounted to the back side of the target plate 255a to keep its temperature above dew point to prevent adhesion of the condensables (including organics) on the target plate which could adversely affect solid engagement with the electromagnet 252 of the electromagnetic clamp. The strip heater 259 is schematically represented by the solid structure shown in FIG. 14 at the base of target plate 255a. The heater 259 is electrically coupled to an electric power source such as power source 251 seen in FIG. 16. The electromagnet 252 generally can be expected to stay hot enough due to heat produced by the electromagnet when energized via application of electric current from the power source to prevent adhesion of the condensables onto the electromagnet. As an additional measure or instead of using a strip heater, the valve seat sealing air of the seal air system previously described herein can also be heated to a temperature above the dew point of the gas stream to further prevent the sticky condensable material from adhering to the end and lateral seat plates.

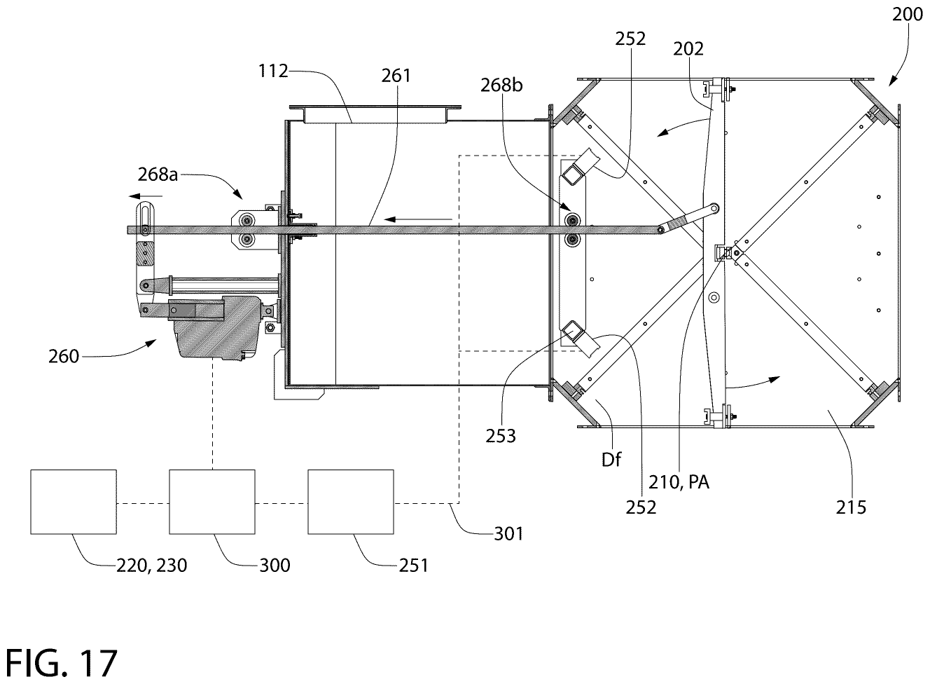

The damper blade 202 of gas flow control valve 200 is pivotably movable between two operating positions including a normal operating position and a regeneration operating position previously described herein. FIGS. 16 and 18 show the blade in the regeneration and normal operating positions of valve 200, respectively (note change in directional gas flow arrows). FIG. 17 shows the blade midway between the two positions during the changeover accomplished via controller 300 actuating the actuator 260. In the normal operating position also shown FIG. 18, the valve 202 fluidly couples the inlet duct 112 which receives untreated process gas from the fan 123 to the entrance duct 113 of the RTO unit 100, and the exit duct 114 from the RTO unit receiving treated gas to the exhaust duct 115 coupled to the stack 104 (see also directional gas flow arrows 110 in FIG. 3). Untreated gas flow through the RTO unit is upwards through the lower and upper ceramic media beds 103a, 103b. Conversely, when the damper blade is in the regeneration operating position shown in FIG. 16, the valve 202 fluidly couples the inlet duct 112 from the fan to the exit duct 114 at the top of the RTO unit 100, and the entrance duct 113 of the unit to the exhaust duct 115 coupled to the stack 104. This regeneration position of the valve 200 creates a gas flow path in which the untreated gas flows downwards through the ceramic media beds 103a, 103b (counter and opposite to the directional gas flow arrows 110 in FIG. 3) to regenerate the upper ceramic media bed 103b as previously described herein.

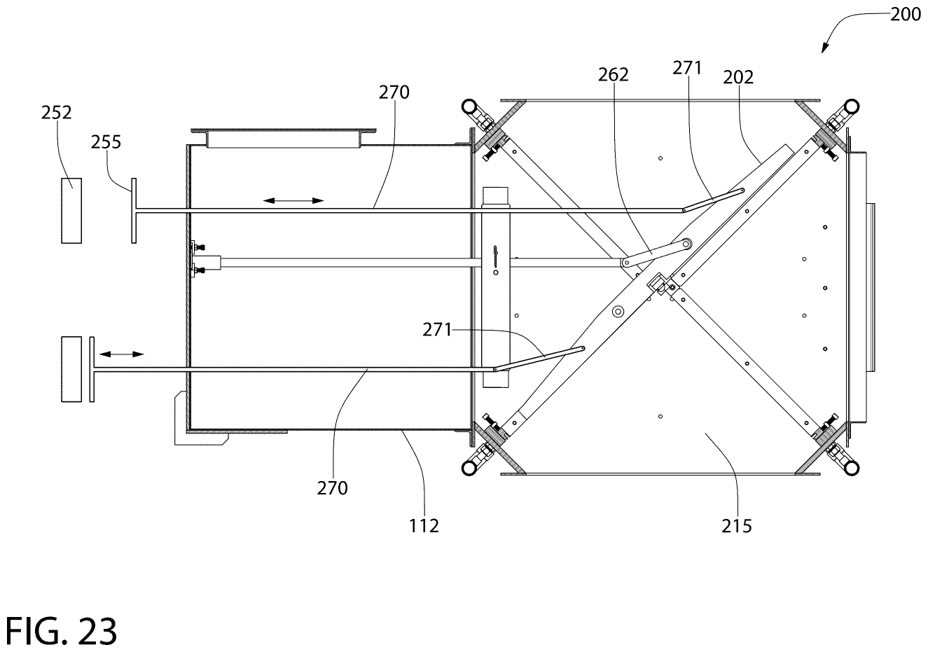

In an alternative embodiment shown schematically in FIG. 23, the electromagnets 252 of the electromagnetic clamps 250 can be located outside of the gas stream and valve housing 201 (i.e. externally) in lieu of being located internally inside the internal cavity 217 of the valve housing as originally described herein. This alternative external arrangement of the electromagnetic clamps can be achieved by provision of an extension arm 270 pivotably coupled to each end portion of the valve damper blade (on each side of blade shaft) via double pinned coupling links 271 which are similar to coupling link 262 associated with the actuator 260 and operating rod 261 shown in FIGS. 5-6. The arrangement and function would be analogous to and similar to the operating rod 261 of the valve actuator 260 system previously described herein. The extension arms 270 may extend inside internal cavity 217 of the valve housing 201 through the inlet duct 112 and terminate at a point outside the duct as shown in FIG. 23. A first blade extension arm 270 comprises a distal end coupled to the damper blade 202 at a first position above pivot axis PA of the damper blade 202, and a proximal end terminated with a first electromagnet target 255 positioned proximate to the first electromagnet 252. The first electromagnet is operable to magnetically attract the first electromagnet target when energized to retain the damper blade in the first position. A second blade extension arm 270 comprises a distal end coupled to the damper blade 202 at a second position below the pivot axis PA of the damper blade 202, and a proximal end terminated with a second electromagnet target 255 positioned proximate to the second electromagnet 252 as shown. The second electromagnet is operable to magnetically attract the second electromagnet target when energized to retain the damper blade in the second position. The extension arms 270 may be formed by a suitably rigid structural member such as for example without limitation a solid or hollow metal rods or tubes.

Two roller guides (not shown in FIG. 23) similar to roller guides 268a, 268b described elsewhere herein associated with guiding the actuator operating rod 261 may similarly be provided to smoothly guide the back and forth movement of the extension arms 270 as the valve damper blade 202 moves between its normal and regeneration positions. The extension arms 270 each include an electromagnet target 255 at the external terminal ends of the arms as shown in lieu of mounting the targets to the damper blade inside the valve housing 201 as previously described. The electromagnets 252 of each electromagnetic clamp are located externally to the inlet duct 112 and positioned to be physically engaged by and magnetically locked to the targets when the damper blade changes between the normal and regeneration positions. The magnetic attraction force generated by the electromagnets is mechanically transferred to the blade external to the valve housing to maintain a tight gas seal between the blade and valve seats, while advantageously keeping the electromagnets themselves out of potentially high temperature and/or corrosive atmospheres in the gas stream flowing within the valve housing 201. This also eliminates the issue of sticky condensables in the gas stream from adhering to the electromagnets 252 and targets 255. The present external electromagnetic clamps 250 operate in the same manner as previously described herein for the internal electromagnetic clamps.

An automatically-controlled blade actuation system is provided which is operable to change the valve 200 positions between the normal and regeneration positions previously described herein. Referring to FIGS. 4-6 and 10-12 at present, the blade actuation system in one embodiment generally includes an electrically-operated linear actuator 260, an operating rod 261 pivotably coupled directly to the damper blade (not the blade shaft as in conventional damper valve designs) via a coupling link 262, and a stroke multiplier linkage 265 which operably couples the operating rod 261 to the actuator 260. The actuator is mounted to and supported by the process gas inlet duct 112 such as on the side wall so that the operating rod is horizontal oriented for coupling to the damper blade 202 in one embodiment as shown. The stroke multiplier linkage 265 is configured to convert the large force, short linear stroke of the actuator shaft 267 to a longer linear stroke of the operating rod for pivotably moving and operating the blade 202. Actuator shaft 267 is moved via operation of the electric motor 263 of the linear actuator. These actuator components may housed and enclosed inside an external actuator housing 260a for protection from the elements.

As best shown in FIG. 6, the stroke multiplier linkage 265 includes pivot arm 269 and an elongated non-movable structural element in the form of a stationary pivot member 264 rigidly affixed to the FTO unit 100 in a cantilevered manner. In one embodiment, the fixed end of the pivot member is attached to the outside of gas inlet duct 112 and the opposite free terminal end portion which projects horizontally outwards therefrom is pivotably coupled to and supports the pivot arm 269 in part via pivot pin 266. Pivot pin 266 defines the pivot axis PA2 of the pivot arm 269. The pivot arm in turn further has a bottom end rotatably coupled to the shaft 267 of the linear actuator 260 and an opposite top end rotatably coupled to the external proximal end 261a of the operating rod 261 which projects outward from inlet duct 112 of the RTO unit 100. The pivot axis PA2 of the pivot arm 269 is located between its ends as shown, but preferably located closer to the bottom end than the top end in order to magnify the short stroke of the linear actuator shaft 267 into the larger stroke of the operating rod 261 which is parallel to but vertically offset from the actuator shaft as illustrated. The coupling of the pivot arm to the operating rod, actuator shaft, and stationary pivot member may be formed by pins.

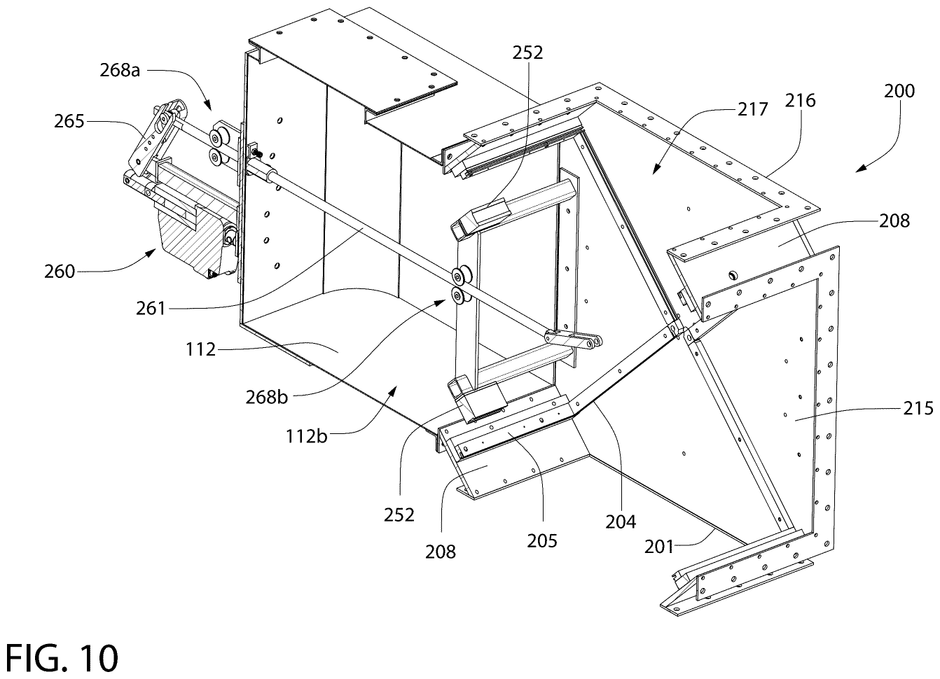

Referring to FIGS. 10 and 16, operating rod 261 of the linear actuator 260 is moveably supported by preferably a pair of linear bearings for projection into and out of internal cavity 217 of gas flow control valve 200. In one embodiment, the bearings may comprise two roller guides 268a, 268b to guide and support operating rod 261 as it moves linearly back and forth between the normal and regeneration positions. The operating rod may be 5 feet or more in length since it must extend laterally through the process gas inlet duct 112 from side to side and into valve housing 201 for a distance for coupling to the damper blade 202. The operating rod 261 is also exposed to the hot process gas which can lead to bowing if not properly supported along its length in a movable manner as the actuator 260 is actuated. Accordingly, some preferred embodiments as shown may include at least two roller guides spaced apart along the length of the operating rod. In the non-limiting illustrated embodiment, one roller guide 268a may be mounted to the exterior of gas inlet duct 112 and the other roller guide 268b may be mounted inside the internal cavity 201 of valve 200 proximate to the inlet duct entrance to avoid interference with the pivotable toggle movement of the damper blade 202 between its two operating positions.

Each of the roller guides 268a, 268b in one embodiment may be formed by a pair of opposed pulley-shaped wheels or rollers with circumferentially-extending channels configured to engage opposite sides of the operating rod. The channels of the rollers collectively define a generally cylindrical shaped through passage therebetween. The through passage slideably guides and supports the operating rod 261 for back/forth linear movement to alter position of the damper blade 202. The distal end portion of the operating rod which extends into internal cavity 217 of the valve housing 201 passes between and is movably supported by roller guide 268b which rotatably attached to the valve body. The distal end of the operating rod 261 inside valve 200 opposite to the proximal end of the rod coupled to the pivot arm 269 outside the gas inlet duct 112 previously described herein is coupled to the damper blade 202 of the valve to actuate and alter position of the blade.

In one embodiment, coupling link 262 is provided which has one end pivotably coupled to the center bracing member 207 on the damper blade 202 and an opposite end pivotably coupled to the distal end of the operating rod 261 (see, e.g., FIG. 6). Coupling link 262 is coupled to the damper blade at a location off-center from the pivot axis PA of the blade defined by blade shaft 210. The center bracing member includes a laterally open operating rod coupling hole to allow one end of the coupling link 262 to be pinned to the bracing member in a pivotably movable manner. The other end of the link is pivotably pinned to the end of the rod. It bears noting that the coupling link allows the blade to pivotably move relative to the operating rod which maintains a horizontal position and moves in a linear manner as restrained by the roller guides 268a, 268b. The coupling link forms a double-joined coupling or connection between the rod and blade. The coupling link in one embodiment may be in the form of a double-ended clevis plate with opening at both ends for coupling to the operating rod and damper blade.

The damper blade actuation system and other operational aspects of the RTO unit may be automatically controlled in whole or in part by programmable controller 300 (shown schematically in FIG. 16). The controller may control timing and actuation of the damper blade 202 (i.e. positional changes of the valve between normal and regeneration positions) via operable and communicative coupling to the valve linear actuator 260, initiation of the seal air supply or vacuum system fluidly coupled to diagonal end and lateral damper blade seats 205, 204, and selective energization of the electromagnetic clamps 250. The controller is operably coupled to the electric power source 251 for the electromagnets 252 of the clamps to control both energizing the electromagnets and the polarity of electric current supplied to the electromagnets, as further described herein. The controller 300 therefore selectively actuates/activates coordinates the operation each of these systems in a timed and sequence manner as needed to direct the process gas flow through the RTO unit 100 when operating in either the normal or ceramic media bed regeneration modes of operation.

In one exemplary operating scenario, the controller 300 may change position of the damper blade between its two operating positions, and in unison therewith actuate/activate the electromagnetic clamp 250 and seal air supply or vacuum for only those “active” lateral and end seals (e.g., seat plates 204, 205) which will be engaged by the blade as it reaches its next new operating position. The lateral and end seal seat plates vacated by the blade after it changes position no longer need seal air or energization of the electromagnetic clamp. The controller thus is programmed to terminate the seal air and energy to the electromagnetic clamp associated with these operationally “inactive” seals for the time being. This is an energy conservation measure.

The controller 300 may be any suitable commercially-available controller with programmable processor and the usual associated electronic components (e.g., memory, non-transitory storage media, communication ports, power supply, etc.) necessary to provide a fully functional and user-configurable controller. The controller may also be operably and communicably coupled or linked via suitable wired and/or wireless communication links 301 to the foregoing described components or other components of the RTO unit described herein and configurable via programming to control operation of those components.

One method for operating the gas flow control valve generally comprises steps of: providing or having the valve comprising a pivotably movable damper blade disposed inside a housing including a valve seat configured for sealing against the damper blade; rotating the damper blade from a first operating position to a second operating position; and magnetically holding the damper blade in the second operating position which seals and holds the damper blade against the valve seat.

The magnetically holding step may include energizing an electromagnet disposed in the housing which magnetically attracts the damper blade to the electromagnet. The method may further include activating a seal air system to supply pressurized air to the valve seat. The electromagnetic may be energized and the seal air system may be activated automatically the programmable controller operably coupled to thereto. The step of rotating the damper blade includes linearly translating an operating rod coupled directly to the blade which rotates the blade around a pivot axis defined by a blade shaft.

Another method for automatically operating a gas flow control valve generally comprises steps of: providing or having the valve comprising a pivotably movable damper blade disposed in a housing including a first valve seat configured for sealing against the damper blade, and an actuator coupled to the damper blade for changing the damper blade between first and second positions; operably coupling a programmable controller to the actuator, the controller configured to: rotate the damper blade from the first position to the second position; and energize a first electromagnet which magnetically attracts and holds the damper blade in the second position which in turn seals a first end of the damper blade against the first valve seat. The controller is further configured to activate a seal air system to supply a flow of pressurized seal air to the first valve seat. The method further includes the controller being configured to: de-energize the first electromagnet; rotate the damper blade from the second position to the first position; and energize a second electromagnet which magnetically attracts and holds the damper blade in the first position which in turn seals a second end of the damper blade against a second valve seat in the housing. The controller is further configured to stop the flow of pressurized seal air to the first valve seat and start a flow of pressurized seal air to the second valve seat when the damper blade is in the second position.

Yet another method for operating a bi-directional gas flow control valve includes: providing or having the gas flow control valve including a housing defining an internal cavity, and a damper blade pivotably supported in the internal cavity by a blade shaft; placing the damper blade in a first operating position; energizing a first electromagnet with an electric current to attract and hold the damper blade in the first operating position; initiating one of de-energizing the first electromagnet or changing polarity of the electric current supplied to the first electromagnet; rotating the damper blade from the first operating position to a second operating position; and energizing a second electromagnet with the electric current to attract and hold the damper blade in the second operating position. De-energizing the first electromagnet releases the damper blade from the first operating position. Changing polarity of the electric current supplied to the first electromagnet repels the damper blade to drive the damper blade towards the second operating position. The damper blade rotates 90 degrees between the first and second operating positions.

It bears noting that the shape and size of the damper blade, electromagnets, electromagnet targets, blade actuator linkage, RTO unit, gas flow control valve, and other appurtenances and features disclosed herein are all variable and can be changed to suit the needs of the intended RTO application and type of gas stream to be treated for VOC removal in addition to end user preferences.

### EXAMPLES

1. A bi-directional gas flow control valve comprising: a housing defining an internal cavity, a gas inlet, a first gas outlet associated with a first flow path, and a second gas outlet associated with a second flow path; a damper blade pivotably supported in the internal cavity of the housing by a blade shaft; the damper blade pivotably movable between a first operating position to direct a process gas stream from the gas inlet to the first gas outlet, and a second operating position to direct the process gas stream from the gas inlet to the second gas outlet; a plurality of seat plates coupled to the housing in the internal cavity, the seat plates arranged to form a seal around a periphery of the damper blade when in both the first and second operating positions; and an actuator operably coupled to the damper blade in the internal cavity by an operating rod, the actuator operable to move the damper blade between the first and second operating positions.

2. The gas flow control valve according to example 1, wherein the operating rod has a proximate end coupled to the actuator and a distal end coupled to the damper blade.

3. The gas flow control valve according to example 2, wherein the operating rod is coupled to the damper blade at a position off-center from the blade shaft which supports the damper blade.

4. The gas flow control valve according to examples 2 or 3, wherein the operating rod is coupled to the damper blade by a coupling link defining two pivot points.

5. The gas flow control valve according to example 4, wherein a first one of the pivot points is formed between a distal end of the operating rod and the coupling link, and a second one of the pivot points is formed between the coupling link and the damper blade.

6. The gas flow control valve according to example 5, wherein the coupling link is coupled to one of a plurality of elongated blade bracing members attached to the damper blade

7. The gas flow control valve according to any one of examples 1-6, wherein operating rod is linearly movable when actuated by the actuator to alter the damper blade between the first and second operating positions.

8. The gas flow control valve according to example 7, further comprising a pair of linear bearings coupled to the housing.

9. The gas flow control valve according to example 1, wherein the blade shaft is oriented transversely to a direction of flow of gas through the valve.

10. The gas flow control valve according to any one of examples 1-9, wherein the damper blade has a rectilinear configuration comprising a first major surface, a second major surface, a first end, a second end, and a pair of lateral sides extending between the first and second ends.

11. The gas flow control valve according to any one of examples 1-10, further comprising: a first electromagnet disposed inside the internal cavity of the housing, the first electromagnet being operable to magnetically attract and retain the damper blade in the first position; and a second lower electromagnet disposed inside the internal cavity of the housing proximate to the gas inlet, the second electromagnet being operable to attract and retain the damper blade in the second position.

12. The gas flow control valve according to example 11, wherein the first and second electromagnets are located proximate to the gas inlet of the housing.

13. The gas flow control valve according to examples 11 or 12, wherein the first and second electromagnets are operable to draw the damper blade against the seat plates to minimize gas leakage between the first and second flow paths.

14. The gas flow control valve according to any one of examples 11-13, further comprising a first ferrous target coupled to a portion of the damper blade proximate to the first end, and a second ferrous target coupled to a portion of the damper blade proximate to the second end, the first and second ferrous targets positioned to engage the first and second electromagnets respectively.

15. The gas flow control valve according to example 14, wherein each of the first and second ferrous targets are magnetically isolated from the damper blade of metallic construction by a non-ferrous isolation member.

16. The gas flow control valve according to any one of examples 11-15, when the first and second electromagnets are electrically coupled to an electric source under control of a programmable controller also operably coupled to the actuator, the controller operable to selectively energize and de-energize the first and second electromagnets.

17. The gas flow control valve according to example 16, wherein the controller is configured to (i) energize the first electromagnet and de-energize the second electromagnet when the damper blade is in the first operating position, and (ii) de-energize the first electromagnet and energize the second electromagnet when the damper blade is in the second operating position.

18. The gas flow control valve according to examples 16 or 17, wherein the controller is further configured and operable to reverse electric polarity of electric supplied to the first and second electromagnets.

19. The gas flow control valve according to example 18, wherein a first polarity causes the first or second electromagnets to attract the damper blade, and a second polarity causes the first or second electromagnets to repel the damper blade.

20. The gas flow control valve according to example 17, wherein the controller is configured to actuate the actuator to change the damper blade from the first operating position to the second operating position simultaneously with energizing the first electromagnet and de-energizing the second electromagnet.

21. The gas flow control valve according to any one of examples 2-7, further comprising a gas inlet duct coupled to the gas inlet of the housing which receives gas from a fan, the operating rod extending through the inlet duct into the internal cavity of the housing to the damper blade.

22. The gas flow control valve according to example 21, wherein the actuator is attached to and supported by the gas inlet duct.

23. The gas flow control valve according to example 1, wherein the first and second gas outlets are fluidly coupled to an internal space of a regenerative thermal oxidizer unit comprising a lower ceramic media bed and an upper ceramic media bed operable to absorb and retain heat from the process gas stream when flowing therethrough.

24. The gas flow control valve according to example 23, wherein the process gas stream flows through the lower and upper ceramic media beds in a first direct when the damper blade is in the first operating position, and the process gas stream flows through the lower and upper ceramic media beds in an opposite second direction when the damper blade is in the second operating position.

25. The gas flow control valve according to any one of examples 1-10, further comprising: a first electromagnet disposed outside the internal cavity of the housing, the first electromagnet being operably coupled to the damper blade by a first blade extension arm comprising a distal end coupled to the damper blade at a first position above a pivot axis of the damper blade, and a proximal end terminated with a first electromagnet target positioned proximate to the first electromagnet, the first electromagnet being operable to magnetically attract the first electromagnet target when energized to retain the damper blade in the first position; and a second electromagnet disposed outside the internal cavity of the housing, the second electromagnet being operably coupled to the damper blade by a second blade extension arm comprising a distal end coupled to the damper blade at a second position below the pivot axis of the damper blade, and a proximal end terminated with a second electromagnet target positioned proximate to the second electromagnet, the second electromagnet being operable to magnetically attract the second electromagnet target when energized to retain the damper blade in the second position.

26. The gas flow control valve according to example 25, wherein the first and second blade extension arms extend through the gas inlet of the housing of the gas flow control valve.

27. The gas flow control valve according to example 26, wherein the first and second blade extension arms further extend through a gas inlet duct coupled to the gas inlet of the housing.

28. The gas flow control valve according to any one of examples 25-27, wherein the first and second electromagnets are electrically coupled to an electric source under control of a programmable controller also operably coupled to the actuator, the controller operable to selectively energize and de-energize the first and second electromagnets.

29. The gas flow control valve according to example 28, wherein the controller is configured to (i) energize the first electromagnet and de-energize the second electromagnet when the damper blade is in the first operating position, and (ii) de-energize the first electromagnet and energize the second electromagnet when the damper blade is in the second operating position.

30. The gas flow control valve according to examples 28 or 29, wherein the controller is further configured and operable to reverse electric polarity of electric supplied to the first and second electromagnets.

31. The gas flow control valve according to example 30, wherein a first polarity causes the first or second electromagnets to attract the damper blade, and a second polarity causes the first or second electromagnets to repel the damper blade.

32. The gas flow control valve according to example 29, wherein the controller is configured to actuate the actuator to change the damper blade from the first operating position to the second operating position simultaneously with energizing the first electromagnet and de-energizing the second electromagnet.

33. A method for operating a bi-directional gas flow control valve comprising: providing or having the valve comprising a pivotably movable damper blade disposed inside a housing including a valve seat configured for sealing against the damper blade; rotating the damper blade from a first operating position to a second operating position; and magnetically holding the damper blade in the second operating position which seals and holds the damper blade against the valve seat.

34. The method according to example 33, wherein the damper blade has a rectilinear shaped body.

35. The method according to examples 33 or 34, wherein the magnetically holding step includes energizing a first electromagnet disposed in the housing which magnetically attracts an end portion of the damper blade to the first electromagnet when the damper blade is in the second operating position.

36. The method according to example 35, wherein the damper blade is held against the valve seat in the second operating position by the first electromagnet in opposition to a flowing gas stream which acts against the damper blade in a direction trying to unseat the damper blade from the valve seat.

37. The method according to example 36, further comprising a second electromagnet which magnetically attracted a second end portion of the blade to draw the damper blade against the valve seat when the damper blade is in the first operating position.

38. The method according to example 37, wherein the first electromagnet is energized when the damper blade is in the second operating position and the second electromagnet is de-energized, and the second electromagnet is energized when the damper blade is in the first operating position and the first electromagnet is de-energized.

39. The method according to example 38, further comprising a programmable controller operably coupled to first and second electromagnets, the controller configured to control energizing and de-energizing the first and second electromagnets.

40. The method according to any one of examples 37-39, wherein the first electromagnet is located above a pivot axis of the damper blade, and the second electromagnet is located below the pivot axis of the damper blade.

41. The method according to any one of examples 33-38, wherein the valve seat is collectively formed by a plurality of lateral and end seat plates fixedly coupled to the housing of the valve.

42. The method according to example 41, further comprising a step of activating a seal air system which supplies pressurized air to the valve seat.

43. The method according to example 42, further comprising a programmable controller operably coupled to first electromagnet and the seal air system, the controller automatically energizing the first electromagnet via an electric current and activating the seal air system.

44. The method according to any one of examples 33-43, wherein the step of rotating the damper blade includes linearly translating an operating rod having a proximal end coupled to an actuator and a distal end coupled to the damper blade inside the housing, the operating rod acting to rotate the damper blade about a pivot axis defined by a blade shaft which supports the damper blade from the housing.

45. The method according to example 44, wherein the first operating position of the damper blade is associated with a first gas flow path through the valve, and the second operating position is associated with a second gas flow path through the valve.

46. A method for operating a bi-directional gas flow control valve, the method comprising: providing or having the gas flow control valve including a housing defining an internal cavity, and a damper blade pivotably supported in the internal cavity by a blade shaft; placing the damper blade in a first operating position; energizing a first electromagnet with an electric current to attract and hold the damper blade in the first operating position; initiating one of de-energizing the first electromagnet or changing polarity of the electric current supplied to the first electromagnet; rotating the damper blade from the first operating position to a second operating position; and energizing a second electromagnet with the electric current to attract and hold the damper blade in the second operating position.

47. The method according to example 46, wherein de-energizing the first electromagnet releases the damper blade from the first operating position.

48. The method according to example 46, wherein changing polarity of the electric current to the first electromagnet repels the damper blade to drive the damper blade towards the second operating position.

49. The method according to example 46, wherein the damper blade rotates 90 degrees between the first and second operating positions.

50. The method according to any one of examples 46-49, wherein the step of rotating the damper blade includes actuating an actuator comprising an operating rod coupled to the damper blade inside the internal cavity of the housing off-center from a pivot axis of the damper blade, and linearly moving the operating rod which rotates the damper blade between the first and second operating positions.

51. The method according to example 50, wherein moving the operating rod in a first linear direction moves the damper blade from the first position to the second position, and moving the operating rod in an opposite second linear direction moves the damper blade back to the first position.

52. The method according to examples 50 or 51, wherein the actuator includes a stroke multiplier linkage configured to convert a short linear stroke of an actuator shaft of the actuator to a longer linear stroke of the operating rod of the actuator for rotating the damper blade.

53. The method according to example 52, wherein the stroke multiplier linkage includes a pivot arm having a first end rotatably coupled to actuator shaft of the actuator and an opposite second end rotatably coupled to the operating rod.

54. The method according to example 46, wherein the damper blade is magnetically held against a plurality of seat plates in the first operating position by the first electromagnet in opposition to a flowing gas stream which acts against the damper blade in a direction trying to unseat the damper blade from the seat plates.

55. The method according to any one of examples 46-54, wherein the first operating position of the damper blade is associated with a first gas flow path through the valve, and the second operating position is associated with a second gas flow path through the valve.

56. The method according to example 55, wherein the valve is fluidly coupled to a regenerative thermal oxidizer unit, the first gas flow path operable to flow process gas from the valve in a first flow direction through the unit, and the second gas flow path operable to flow the process gas from the valve in an opposite second direction through the unit.

57. The method according to example 50, further comprising supporting the operating rod via a pair of spaced apart linear bearings for linear movement back and forth.

58. The method according to example 57, wherein each linear bearing comprises a pair of opposed rollers, the operating rod passing between the pair of rollers.

While the foregoing description and drawings represent some example systems, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

1. A bi-directional gas flow control valve comprising:
a housing defining an internal cavity, a gas inlet, a first gas outlet associated with a first flow path, and a second gas outlet associated with a second flow path;
a damper blade pivotably supported in the internal cavity of the housing by a blade shaft;
the damper blade pivotably movable between a first operating position to direct a process gas stream from the gas inlet to the first gas outlet, and a second operating position to direct the process gas stream from the gas inlet to the second gas outlet;
a plurality of seat plates coupled to the housing in the internal cavity, the seat plates arranged to form a seal around a periphery of the damper blade when in both the first and second operating positions; and
an actuator operably coupled to the damper blade in the internal cavity by an operating rod, the actuator operable to move the damper blade between the first and second operating positions.

2. The gas flow control valve according to claim 1, wherein the operating rod has a proximate end coupled to the actuator and a distal end coupled to the damper blade.

3. The gas flow control valve according to claim 2, wherein the operating rod is coupled to the damper blade at a position off-center from the blade shaft which supports the damper blade.

4. The gas flow control valve according to claim 3, wherein the operating rod is coupled to the damper blade by a coupling link defining two pivot points.

5. The gas flow control valve according to claim 4, wherein a first one of the pivot points is formed between a distal end of the operating rod and the coupling link, and a second one of the pivot points is formed between the coupling link and the damper blade.

6. The gas flow control valve according to claim 5, wherein the coupling link is coupled to one of a plurality of elongated blade bracing members attached to the damper blade

7. The gas flow control valve according to claim 1, wherein operating rod is linearly movable when actuated by the actuator to alter the damper blade between the first and second operating positions.

8. The gas flow control valve according to claim 7, further comprising a pair of linear bearings coupled to the housing which movably support the operating rod.

9. The gas flow control valve according to claim 1, wherein the blade shaft is oriented transversely to a direction of flow of gas through the valve.

10. The gas flow control valve according to claim 1, wherein the damper blade has a rectilinear configuration comprising a first major surface, a second major surface, a first end, a second end, and a pair of lateral sides extending between the first and second ends.

11. The gas flow control valve according to claim 1, further comprising:
a first electromagnet disposed inside the internal cavity of the housing, the first electromagnet being operable to magnetically attract and retain the damper blade in the first position; and
a second lower electromagnet disposed inside the internal cavity of the housing proximate to the gas inlet, the second electromagnet being operable to attract and retain the damper blade in the second position.

12. The gas flow control valve according to claim 11, wherein the first and second electromagnets are located proximate to the gas inlet of the housing.

13. The gas flow control valve according to claim 11, wherein the first and second electromagnets are operable to draw the damper blade against the seat plates to minimize gas leakage between the first and second flow paths.

14. The gas flow control valve according to claim 11, further comprising a first ferrous target coupled to a portion of the damper blade proximate to the first end, and a second ferrous target coupled to a portion of the damper blade proximate to the second end, the first and second ferrous targets positioned to engage the first and second electromagnets respectively.

15. The gas flow control valve according to claim 14, wherein each of the first and second ferrous targets are magnetically isolated from the damper blade of metallic construction by a non-ferrous isolation member.

16. The gas flow control valve according to claim 11, when the first and second electromagnets are electrically coupled to an electric source under control of a programmable controller also operably coupled to the actuator, the controller operable to selectively energize and de-energize the first and second electromagnets.

17. The gas flow control valve according to claim 16, wherein the controller is configured to (i) energize the first electromagnet and de-energize the second electromagnet when the damper blade is in the first operating position, and (ii) de-energize the first electromagnet and energize the second electromagnet when the damper blade is in the second operating position.

18. The gas flow control valve according to claim 16, wherein the controller is further configured and operable to reverse electric polarity of electric supplied to the first and second electromagnets.

19. The gas flow control valve according to claim 18, wherein a first polarity causes the first or second electromagnets to attract the damper blade, and a second polarity causes the first or second electromagnets to repel the damper blade.

20. The gas flow control valve according to claim 17, wherein the controller is configured to actuate the actuator to change the damper blade from the first operating position to the second operating position simultaneously with energizing the first electromagnet and de-energizing the second electromagnet.

21. The gas flow control valve according to claim 2, further comprising a gas inlet duct coupled to the gas inlet of the housing which receives gas from a fan, the operating rod extending through the inlet duct into the internal cavity of the housing to the damper blade.

22. The gas flow control valve according to claim 21, wherein the actuator is attached to and supported by the gas inlet duct.

23. The gas flow control valve according to claim 1, wherein the first and second gas outlets are fluidly coupled to an internal space of a regenerative thermal oxidizer unit comprising a lower ceramic media bed and an upper ceramic media bed operable to absorb and retain heat from the process gas stream when flowing therethrough.

24. The gas flow control valve according to claim 23, wherein the process gas stream flows through the lower and upper ceramic media beds in a first direct when the damper blade is in the first operating position, and the process gas stream flows through the lower and upper ceramic media beds in an opposite second direction when the damper blade is in the second operating position.

25-58. (canceled)
